(19) United States
(12) Patent Application Publication
(10) Pub. No.: US 2019/0340656 A1
(43) Pub. Date: Nov. 7, 2019

(54) METHOD, SYSTEM, AND APPARATUS FOR AUTOMATED PROPULSION OF SELF-SERVICE STORES FOR DIGITAL-CONTENT MONETIZATION

(71) Applicant: Ratko Orlandic, Seattle, WA (US)

(72) Inventor: Ratko Orlandic, Seattle, WA (US)

(21) Appl. No.: 16/399,846

(22) Filed: Apr. 30, 2019

Related U.S. Application Data
(60) Provisional application No. 62/665,636, filed on May 2, 2018.

(51) Int. Cl. G06Q 30/02; G06F 3/0481

(52) U.S. Cl. CPC G06Q 30/0275; G06Q 30/0246; G06F 3/04817; G06Q 30/0269; G06Q 30/0261

(57) ABSTRACT

The invention addresses the problem of building self-service systems for digital-content monetization that may attract and grow advertising supply and demand mainly through their internal programmatic means. The invention reduces the need for external propulsion through a costly sales force and business-development interventions, and serves as a mechanism for boosting user acquisition and monetization of the system itself. The invention employs three types of store fronts with special insights designed to facilitate the attainment of user, publisher and advertiser objectives and to increase the likelihood of favorable events for the system's automated propulsion. The propulsion method exploits asymmetry in the relationships between advertisers, publishers, and users in order to grow supply and demand synchronously while employing an advertising model based on digital-content sponsorship in the form of programmatic-direct advertising.

### CROSS-REFERENCE TO RELATED APPLICATIONS

This application claims priority to a prior-filed provisional application Ser. No. 62/665,636 filed on May 2, 2018.

### FIELD OF DISCLOSURE

The overall field of this invention relates to the monetization of digital content through advertising. More particularly, the patent proposes an affordable mechanism for growing supply and demand in self-service systems for digital-content monetization.

### BACKGROUND OF THE INVENTION

Contemporary content monetization systems typically employ real-time bidding RTB based on first-price or second-price auctions. RTB auctions are typically conducted by a computational infrastructure that includes a supply-side platform and one or more demand-side platforms. In mobile environments, publishers must integrate their digital contents with the software development kit of the given system and advertisers must submit advertisement campaigns. The RTB auction is initiated whenever a user of some mobile digital content comes to a place with one or more advertisement slots, or impressions. A supply-side platform then submits bids on behalf of a publisher.

Supply-side platforms can range in complexity from a relatively simple advertisement server to a refined system with, among other capabilities, an advanced yield-maximization technique. Demand-side platforms comprise sophisticated predictive systems for programmatic bidding. For a given impression, a demand-side platform must automatically decide whether the advertiser should buy the impression and, if so, determine an associated price to pay. Both decisions are typically governed by an advertiser's campaign criteria. A bid is submitted as part of a bid response. Communication between a supply-side platform and a demand-side platform must adhere to a common protocol, such as the Interactive Advertising Bureau IAB OpenRTB Specification.

Private marketplace PMP is a way of structuring an RTB auction. PMP includes a protocol for an invitation-only auction, in which a publisher or a group of publishers invite a select group of advertisers to bid on inventory of advertisement slots for no less than a designated minimum value. Thus, a buyer may know where an advertisement will be displayed. A unique identifier, in the present case a Deal ID, is generated to represent an implied or direct deal between a buyer and a seller. The PMP is structured as a hierarchy of bids from different channels. Open auctions, in which anybody can bid, are usually profiled at the bottom of such a hierarchy. In one approach, known as the waterfall approach, top-level bids are examined first, and lower-priority bids are examined only if no higher-priority bids are present. An alternative approach, found in header bidding, involves allowing multiple demand sources at different levels to bid on a common inventory of advertisement slots simultaneously, causing a potential increase in a publisher's yield.

Higher levels of a private marketplace are typically reserved for direct buys or programmatic direct, both of which are forms of premium advertising. Direct buy involves purchase of impressions within specific types or locations of content; with terms of a contract being pre-negotiated in the course of a direct negotiation between the seller and buyer. Thus, inventory allocation takes place before an RTB auction is conducted.

Programmatic direct is a way of approximating the benefits of direct buys and tapping into the publisher's premium inventory within an auction framework. Programmatic direct may have different variants mapped to different levels or channels of a private marketplace. The highest level of the private marketplace is typically reserved for guaranteed deals in which an advertiser specifies an impression goal for each content targeted by a campaign. For example, at a fixed price, this channel may guarantee an impression goal of an advertiser, but not necessarily the content. A pricing level below is usually reserved for settled, or fixed-price programmatic channels that provide guarantees regarding content but do not give guarantees on impressions. A pricing level below the previous may be reserved for bids on restricted deals with a minimum price higher than potential minimum prices in similar open auctions. This channel also provides content guarantees.

With most advertising networks, systems for monetization of digital content on mobile devices are designed to specifically benefit advertisers, publishers, and users. The inventory of content comprises an audience consuming the content. As soon as the content is integrated with the advertising network for the purposes of serving the advertisements, the audience of the content becomes the advertising supply. Users usually consume digital content that is appealing and easily accessible, such as on a mobile device. A primary concern for advertisers remains successful attainment of targeting objectives for their advertising campaigns. Objectives are expressed as a combination of contextual indicators and user geographic, demographic, or behavioral indicators. Specifically, in mobile advertising, a contextual target may be one or more digital contents or selected placements within a given piece of content.

However, relationships between advertisers, publishers, and users are not typically symmetric: each entity drives and impacts another, giving rise to a cyclic dependency chain. Advertisers and given demand have an impact on publishers in that publishers tend to migrate to content monetization platforms that cultivate large demand levels. Users, in turn, have an impact on advertisers in that advertisers typically follow an appropriate audience. Publishers provide such an audience, provided that the digital content is appealing to users in that audience and is integrated with the required components of the advertising system.

This cyclic dependency chain presents a significant problem for content monetization systems based on advertising. Associated large fluctuations in prices of advertisements and advertisement fill rates based on given supply or demand quantities also present a challenge. For a relatively stable demand, as supply increases, pricing for advertisements decrease, as do advertisement fill rates. Publishers producing less-than-anticipated returns from advertising begin to migrate elsewhere. As this happens, prices and fill rates begin to recover, eventually to a point when publishers are once again attracted back. For a relatively stable supply as demand grows, competition for available inventory increases to a point where fewer advertisers can bear any ensuing increase in the price of ads. Advertisers begin pulling back, gradually creating improved conditions for more affordable prices. Even in a dynamic multi-dimensional world, most content monetization systems are vulnerable to sudden shifts in supply or demand.

Present computational advertising enterprises address these problems by employing “external propulsion” of their systems through a significant sales force and continuous business-development efforts catering to both advertisers and publishers. Even with a large and expensive sales force and a dynamic business development, a reasonable price and fill-rate stability can still be unattainable. There is, therefore, a present need for solutions that rely on “internal propulsion” of digital-content monetization systems through an affordable framework that enables sustained reasonable advertisement prices and fill-rate stability.

### BRIEF DESCRIPTION OF THE INVENTION

The application presents an inventive system and method for programmatic-based propulsion of self-service advertising platforms for digital-content monetization. The inventive method reduces the need for external propulsion of such platforms by a large sales force and expensive marketing efforts. It also minimizes the negative effects of the cyclic dependency chain and the wild shifts in supply and demand. The invention achieves this by: exploiting the attractions between the advertisers, publishers and users; enabling a synchronous growth of the supply and demand; and implicitly incentivizing external events beneficial to the growth of supply and demand.

The invention comprises a digital content store having a mechanism for programmatic propulsion of content monetization. The store comprises three or more store fronts and a plurality of internal protocols and systems specifically configured to achieve the desired effects while serving the needs of the entities involved; including publishers, users and advertisers. The store is also configured to attract an amount of available digital content greater than the content already integrated with it for the purposes of advertising. The store is further configured to support appropriate views and insights channeling the activities of the participants toward effective system propulsion.

The invention reduces the probability of disruptive shifts in supply or demand through a synchronous growth of supply and demand, in which advertisers lure into the digital-content store high quality supply through a process of natural selection. The method also utilizes one or more programmatic direct channels for premium advertising in order to achieve a level of price stability that further inhibits shifts in supply and demand. In order to maintain relatively high fill rates in integrated contents, the method further employs open auctions soliciting bids from various demand sources in addition to a native source.

### BRIEF DESCRIPTION OF THE DRAWINGS

FIG. 1 presents a table with the properties of three programmatic-direct channels for premium advertising.

FIG. 2 is a high-level diagram of components and interactions in a system with the inventive method embodied in the patent application.

FIG. 3 illustrates one of the possible layouts of the User Store home page, called the organic view.

FIG. 4 illustrates a possible layout of the “Sponsors” widget on the digital-content detail page in the User Store.

FIG. 5 shows a layout of the screen in the Publisher Store through which publishers submit the details for advertisers describing the digital content.

FIG. 6 gives an example of the screen in the Publisher Store through which publishers provide information about the demographics of the content's audience.

FIG. 7 exemplifies an important screen in the Publisher Store for the store's automated propulsion, which summarizes the sponsorship support.

FIG. 8 illustrates a layout of the user-engagement screen in the Publisher Store.

FIG. 9 exemplifies a screen in the Publisher Store to track in-content advertising performance.

FIG. 10 shows a possible layout of the home page of the Advertiser Store.

FIG. 11 illustrates a possible layout of the digital-content detail page in the Advertiser Store.

FIG. 12 gives a layout of a screen of the Advertiser Store presenting the content's user demographics.

FIG. 13 shows a possible layout of the screen on a detail page that presents relevant statistics to advertisers.

FIG. 14 exemplifies a possible layout of the advertisers' segment-definition page.

FIG. 15 illustrates a possible layout of the advertisers' campaign-setup page.

FIG. 16 shows the structure of a content-description event.

FIG. 17 illustrates the structure of a telemetry event.

FIG. 18 gives an example of a bid request generated by the supply-side platform after receiving an advertisement call.

FIG. 19 depicts the structure of a bid reply sent by a demand-side platform in response to a bid request.

FIG. 20 illustrates a reporting event for the publisher or advertiser insights into advertising performance.

FIG. 21 illustrates the components and processes of an implementation of the store's digital-content sponsorship platform relevant to the inventive method.

FIG. 22 gives a high-level representation of a pipeline that propagates the content-description events from the Publisher Store to the Advertiser Store.

FIG. 23 schematically diagrams the pipeline of telemetry reporting.

FIG. 24 illustrates the process of real-time bidding for digital-content sponsorship in User Store.

FIG. 25 gives a schematic diagram of the bidding process for in-content sponsorship or open-action ads.

FIG. 26 illustrates the components of a general-purpose computer interconnected via a system bus.

FIG. 27 is a flow diagram illustrating the steps of the inventive method for programmatic propulsion of self-service stores for monetization of digital contents through advertising.

### DETAILED DESCRIPTION OF THE INVENTION

Overview of the Inventive Method

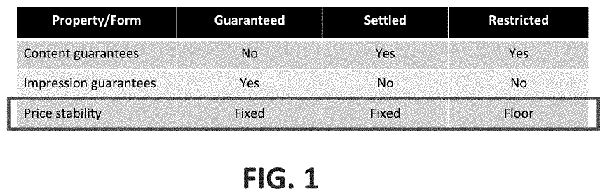

A key to growing digital-content monetization systems by programmatic means is to ensure a synchronous growth of supply and demand while limiting the advertisement price fluctuations. FIG. 1, which summarizes the main properties of three programmatic-direct channels, highlights the fact that programmatic direct acts as a natural price stabilizer—ad price is either fixed or has at least a lower bound. Programmatic direct channels also provide content or impression guarantees. In mobile environments, advertiser who secures an advertisement placement may also count on fewer competing advertisements in the same view than in online environments. To a publisher, premium has been a preferred form of advertising, albeit hard to attract in the online world. To a publisher of mobile digital content, who does not have an unlimited pool of impressions, premium advertising is even more appealing.

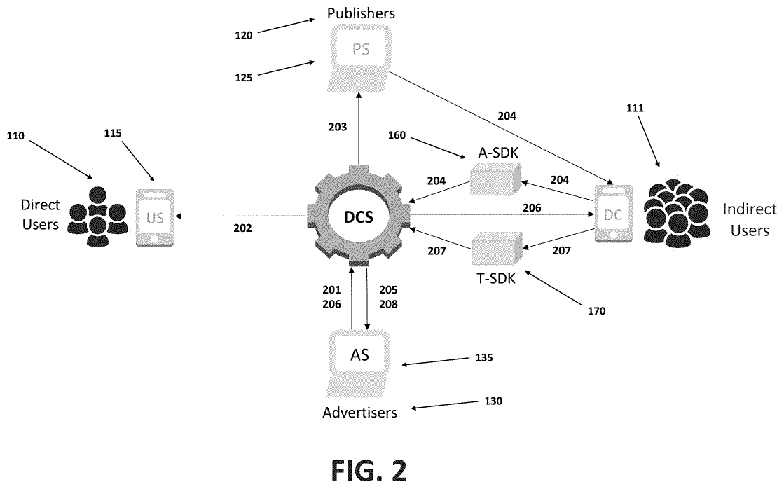

FIG. 2 illustrates an embodiment of automated self-service propulsion system 100 utilizing digital-content sponsorship DCS. Sponsorship in the present context is taken in its accepted sense as a conscious act of providing financial support to a publisher 120 in exchange for advertising. The invention comprises at least one store front configured to display sample digital content on a mobile device. Store fronts may have a plurality of buttons or icons that are selectable through a user interface to instruct to perform particular processes in response to the selections. System 100 also comprises at least two modular kits configured to enable software development for digital content integration. The modular kits may include a telemetry kit 170 T-SDK configured to collect relevant user-engagement data and transmit the data to the back-end system infrastructure; and an advertising kit 160 A-SDK configured to facilitate in-content advertising. Digital content integration with telemetry kit 170 allows publishers 120 to automatically present to advertisers 130 relevant data about the behavioral aspects of the audience and gradually gain inventory appreciation. The integration with advertising kit 160 gives publishers 120 the ability to monetize their content. In one or more non-limiting embodiments of the invention, content available to a store comprises all digital content integrated through distribution interactions, advertising interactions, and telemetry kit 170.

The store comprises at least three types of store front configurations: a User Store 115 US, a Publisher Store 125 PS, and an Advertiser Store 135 AS. User Store 115 allows direct users 110 to access digital content and view advertisements of potential sponsors. Publisher Store 125 is configured such that publishers 120 may submit digital content as well as monitor sponsorship support, user engagement and overall advertising performance. Advertiser Store 135 is configured to allow the examination of appropriateness of content and its audience, to formulate targeting objectives, and to control where a given investment is allocated, all with the goal of reducing a chance of unsuccessful investment. Similar to User Store 115, Advertiser Store 135 displays relevant data and details about digital content as well as a plurality of generalized views across content of a given publisher 120 or category. For digital content integrated with the store's telemetry kit 170, a detail page of Advertiser Store 135 receives and displays information and aggregated engagement statistics relevant to advertisers 130, enabling well formulated, targeted campaigns that target segments of audience of one or more digital contents.

Users 110 of User Store 115 are the store's direct audience. Audience of any digital content integrated with advertising software development kit 160 represent indirect users 111 of the store. An example of an audience of indirect users 111 may be the users of a mobile application on a computing device. Indirect users 111 may install the application on their computing device through various channels, not necessarily through the User Store 115. However, as long as the application is integrated with advertising software development kit 160, they may become indirect users 111. This is because, whenever a user 111 of the application views an advertisement procured through advertising software development kit 160, part of the revenue from that advertisement impression goes to the digital-content store; while the remaining amount of revenue belongs to the publisher 120 of the application.

In another embodiment of the invention, sponsors may create, charter, and place advertisements in User Store 115, such as on a home page. A placed advertisement may be, for example, a brief message under an icon of a digital content that includes the sponsor's name or logo. On a detail page, a widget may be configured to display one or more advertisements of different sponsors. Revenue from advertisements on a home page and a detail page may go to the store.

In another embodiment of the invention, digital content may be configured to give publishers 120 an opportunity to monetize content through programmatic direct channels for sponsorship advertisements or through advertisements procured in open auctions. In order to maintain high fill rates in internal advertisement placements, a store's advertising platform may be configured to allow advertisements from various sources, including programmatic direct and open auction channels.

Sponsors may get a premier treatment with guarantees and the ability to tap into a large inventory of digital content where their advertisements may reach right audience and deliver intended marketing impact. Sponsors that indirectly contribute to bringing a digital content into the network may be the first beneficiaries of the content's inventory. This is partly because they are immediately notified by the store when such content integrates with advertising kit 160 and partly because their advertisements may be served at a higher priority level of the private marketplace stack.

The advertising platform may comprise a sponsorship model having a combination of private marketplaces and programmatic direct channels that provides to advertisers 130 content guarantees. This configuration ensures that a given sponsor's advertisement goes to a correctly targeted destination. In addition, a separate programmatic direct channel may be used to provide impression guarantees to advertisers 130. In one or more non-limiting embodiments, all publishers 120 share a common private marketplace, in which deals are constructed automatically. In one or more non-limiting embodiments, the system comprises at least two levels of private marketplace: one for a sponsorship form of programmatic direct that provides content guarantees; and another for open auctions. Sponsors always bid at a level above an open auction. Advertisements on a home or detail page of User Store 115 may be configured such that they only come from programmatic direct channels.

In the inventive method illustrated in FIG. 2, the first contact between a publisher 120 and sponsor is initiated by the sponsor. It comes in the form of a sponsorship message or advertisement at Link 201 on the home or detail page of User Store 115 at Link 202. The amount of sponsorship given to a digital content is summarized in a view within Publisher Store 125 at Link 203. The attractive power of sponsorship support with the prospects of content monetization through premium advertisements may pull into digital content sponsorship a new publisher, who will integrate the content with the store's advertising kit 160 at Link 204. The sponsors of the integrated content are then notified at Link 205 and their advertisements are likely to start serving the audience of the digital content at Link 206.

To further grow the appeal of the digital content's inventory, publisher 120 is likely to integrate said content with the store's telemetry kit 170 at Link 207. The resulting diversification of available inventory and sharpened insights in Advertiser Store 135 at Link 208, together with the alluring effects of premier treatment with guarantees, are likely to attract a greater investment by more marketers at Link 201. Growing demand results in increased publisher 120 loyalty and further diversification of integrated content and available inventory. The process continues, keeping the store growing.

By facilitating the growth of the advertising demand and supply through automated means, said mechanism is configured to reduce associated business development costs and the required sales force. Because a store participates in associated revenue sharing for advertisements served to digital content through the system, users of said content also become that store's users. Since both direct store users and indirect users 110 111 represent an advertising supply, the same mechanism serves as the user-acquisition method. Moreover, since growing demand implies higher monetization, the mechanism also serves as the store's monetization engine. As such, interests of a given store become aligned with interests of the store's publishers 120 and advertisers 130.

In other embodiments of the invention, a store's available digital content may be increased beyond an amount of content integrated with the store for the purposes of distribution, advertising, or telemetry. In other embodiments of the invention, a store may configure an automated framework that periodically sends direct marketing notifications about featured or newly added content to advertisers 130 and advertisement agencies who have not yet committed to the store's sponsorship model, in an effort to garner support. In yet another embodiment of the invention, a recommendation framework may be configured to power insights in Advertiser Store 135 in order to provide advertisers 130 with personalized views of content matching past or current targeting criteria. In another embodiment of the invention, User Store 115 may display sponsorship advertisements in a place other than the home or a detail page, such as in search results.

Private marketplaces, in one or more non-limiting embodiments, may have a plurality of levels above and below an open auction. Levels above an open auction may further be configured to distribute varying types of guarantees; while levels below an open auction may be configured to distribute varying types of publisher 120 engagement campaigns targeting an audience of a store or of a digital content. In other embodiments of the invention, a store's advertising framework may be enhanced with features for performance advertising, direct marketing, or different payment methods and models. In one or more non-limiting embodiments of the invention, automated incentives may be configured to further reduce supply and demand fluctuations.

A system for the distribution and monetization of digital content may be specialized for a content type or serve as a consolidated store for different content types. For example, a store may be devoted to only video or mobile applications. Another may provide an integrated platform for various content types, e.g. video, streaming digital TV, mobile applications, electronic books, and retail digital content. Irrespective of the types of content in the store, the presented propulsion method works the same way. The underlying advertising technology may also be the same.

System Components

A digital content store configured with the inventive method as discussed may include at least three types of store fronts: User Store 115 US, Publisher Store 125 PS, and Advertiser Store 135 AS. Each of the store fronts may be developed for different or similar platforms, facilitating a wider variety of store front users. Each of the store fronts communicates with the digital-content sponsorship DCS platform.

The present invention may comprise at least one method of content integration with a store, such as the advertising A-SDK and telemetry T-SDK software development kits 160 170. Advertising kit 160 and telemetry kit 170 may comprise different instantiations for different platforms. Content submission, content quality control, and various monetization or engagement programs that do not necessarily involve advertising may be included in the system, thereby conferring a positive effect on the system by allowing more content to be integrated with the store. Newly added content may then immediately become a candidate for growing supply within the store monetization framework.

Telemetry kit 170 T-SDK is configured to collect relevant user-engagement data presented to marketers in Advertiser Store 135 as aggregated user geographic and behavioral statistics. Such data is essential for a store's ability to satisfy the needs of advertisers 130. The data also provides a critical path for publishers 120 to gain appreciation for the inventory of digital content among prospective sponsors who, otherwise, would usually stay unknown to or unreachable by publishers 120. A suitable process of inventory appreciation, along with any data that enables the process, is an important prerequisite for monetization. The same telemetry data may also power aggregated digital-content engagement insights in Publisher Store 125 relevant to individual publishers 120.

Telemetry kit 170 may be the same or similar to the telemetry software development kits provided to publishers 120 by different data-analytics vendors. The diversity of the application-programming interfaces of such kits may vary. In a minimal form sufficient for the inventive method, this kit tracks four types of events of the user interaction sessions with the digital content: start, stop, pause, and resume a session. From these, aggregated statistics may be derived about user activity, level of user engagement, as well as location and language distributions. This level of detail is sufficient to enable per-content, per-publisher or per-category aggregated statistics insightful to advertisers 130 and publishers 120 alike. In a more elaborate setup, telemetry kit 170 may be the application programming interface API to a sophisticated analytical system with both descriptive and predictive data-mining capabilities.

Integration with an advertising A-SDK kit is a pre-requisite for the monetization of mobile digital content through ads. The kit may also be used to integrate User Store 115 with the store's digital-content sponsorship framework. Advertising kit 160 may be the software development kit of any contemporary mobile advertising platform, which the vendors of advertising platforms make readily available. An advertising kit 160 usually has classes for different advertisement formats, such as banner, video, audio, and native ads. Critical application programming interfaces of advertising kit 160 include a method for submitting an advertisement call and separate methods for recording related events, such as ad-call failures, impressions and clicks. The Advertising ID, a user identifier used in attribution and reporting, may be automatically derived by an advertising kit 160. The kit may record more than one advertising id.

Similar to the software development kits, the computational infrastructure configured to support digital content sponsorship and the inventive method of this patent may be developed on top of any advertising platform for real-time bidding. The required changes in the advertising platform, which are detailed later in the application, are largely confined to the structures of bid requests and replies, and to the way relevant events are handled in different scenarios. Most subsystems and processes in typical computational advertising platforms may be reused without alteration. These include inventory forecasting, bidding, attribution, billing and payments, and much of the reporting infrastructure.

Store Fronts

User Store 115 may be configured to make digital content accessible to users 110. For some content types, e.g. mobile applications, this means finding and installing the application. For others, e.g. video, this implies finding and playing the content. Albeit not critical for the inventive method, the framework for personalized recommendation of content in User Store 115 is important for the generic mission of the store front. Another objective of the store front is to participate in the monetization of the store itself, e.g. through paid content or advertisements. The store may feature many kinds of ads, not just the sponsorship advertisements required for the store's internal propulsion. In order to reduce the risks of alienating audience of User Store 115, the advertisements must promote brands in nonintrusive ways and their placements should not disturb the store-front's organic nature.

Sponsorship advertisements in User Store 115 serve several objectives in addition to the monetization of the store itself. Through such ads, User Store 115 helps forge mutually beneficial relationships between publishers 120 and advertisers 130 without requiring their direct, one-to-one communication. Sponsorship advertisements in User Store 115 indirectly channel publishers 120 into, potentially lucrative, in-content advertising. They do so by gradually increasing the likelihood that a publisher 120 whose content is being sponsored on User Store 115 will integrate the content with the store's advertising kit 160. From an advertiser's 130 perspective, the advertisements not only promote their brand but also represent a way of drawing select publishers 120 to integrate their content with the store, where the sponsor's advertisements may have more significant marketing impact. This is because the inventive method increases the likelihood that the first beneficiaries of a newly integrated content are advertisers 130 sponsoring the content on User Store 115. On User Store 115, the sponsorship advertisements convey the intent of advertiser 130 to provide financial support to a publisher 120 once publisher 120 integrates the targeted content with the store.

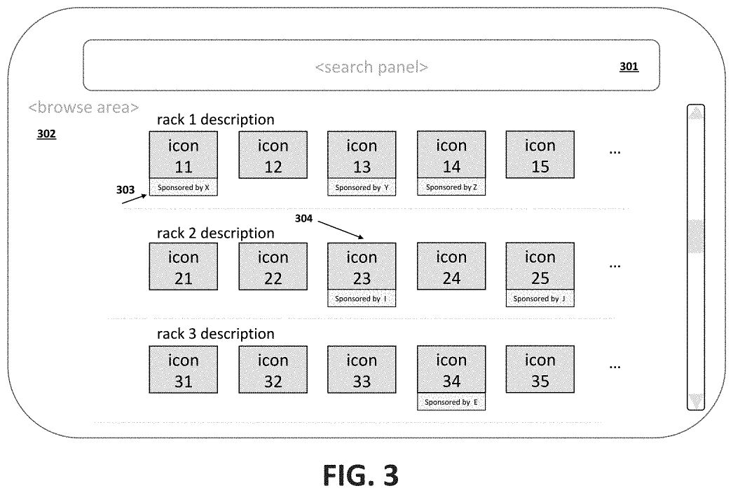

Suitable places where sponsorship advertisements may appear in User Store 115 include home and detail pages featuring specific digital content. Alternative places for sponsorship ads, such as search results, may also be appropriate. FIG. 3 illustrates one of the possible layouts of User Store 115 home page, called the organic view. In a typical layout, this page includes a search panel 301 and browsing area 302. The latter may be organized into racks of digital-content icons, each of which may be devoted to a category of digital content or to content with a degree of relevance to user 110. The sponsorship messages appear underneath the icons of the digital contents that are being sponsored. The advertisements may be brief messages saying, “Sponsored by X” 303, where X is a sponsor's name or logo. Combination of the content's icon and the sponsorship message forms a sponsored icon. Click on the icon brings user 110 to the detail page. Click on the sponsorship message takes user 110 to the sponsor's landing page.

In one or more non-limiting embodiments of the organic view, in the first phase of rendering a home page, User Store 115 recommendation framework decides the content to be displayed. In the second phase, icon of a sponsored content is decorated with the sponsorship message. The latter is obtained through a real-time bidding auction conducted by the digital-content sponsorship platform, which is described later in this section. An alternative embodiment is to place in each rack icons of sponsored content before non-sponsored content icons.

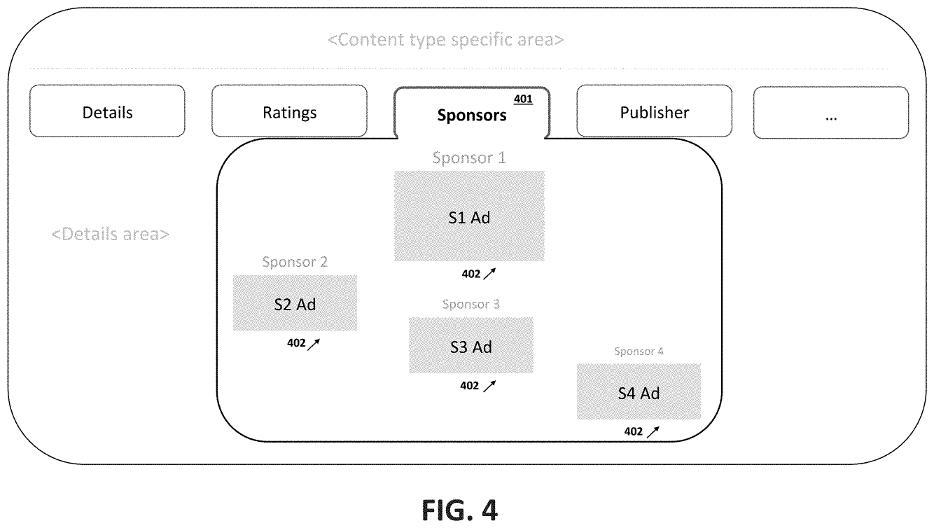

As shown in FIG. 4, detail pages of digital content may further be configured with an important detail, called the “Sponsors” widget 401, in addition to the details that typical digital-content stores provide. The advertisements on the widget are filled through background auctions. Unlike the sponsorship messages on the home page, the advertisements may be of different formats 402. Like the messages on the home page, the advertisements should come only from sponsors whose campaigns specifically target the digital content, its publisher, or a category to which the content belongs.

Explicit pairing of digital content and its sponsors in User Store 115 is important for several reasons. Sponsorship advertisements are more likely to be perceived by the user as endorsements of the content than promotional material. As a result, they are less likely to alienate the user. A promise of sponsorship may be a greater influencer on publishers 120 than some incidental advertisements procured through typical real-time auctions. Advertisers 130 may then have an incentive to pursue sponsorship campaigns not only to have their advertisements in visible places of premier content, such as a User Store 115, but also to draw digital content with appropriate audience into the store. In turn, a store will provide them a top-priority treatment with respect to content they sponsor. With this, the favorable conditions for the internal propulsion of the store begin manifesting themselves in User Store 115.

In order to facilitate the internal propulsion of the store, Publisher Store 125 must provide a front end for publishers 120 to declare details about the submitted digital content relevant to advertisers 130. In addition, special views and widgets must be designed to increase chances they will integrate the content with the store's advertising and telemetry kits 160 170.

As part of the digital-content submission process, Publisher Store 125 will present publisher 120 a page that may include, among other widgets, tabs for providing details specifically for advertisers 130 and describing user demographics. Separate tabs are used for monitoring sponsorship, user engagement, and overall advertising performance. If the content is not integrated with the store's telemetry and advertising kit 160 170, the user-engagement and advertising-performance widgets should be used to inform publisher 120 about the benefits of integration.

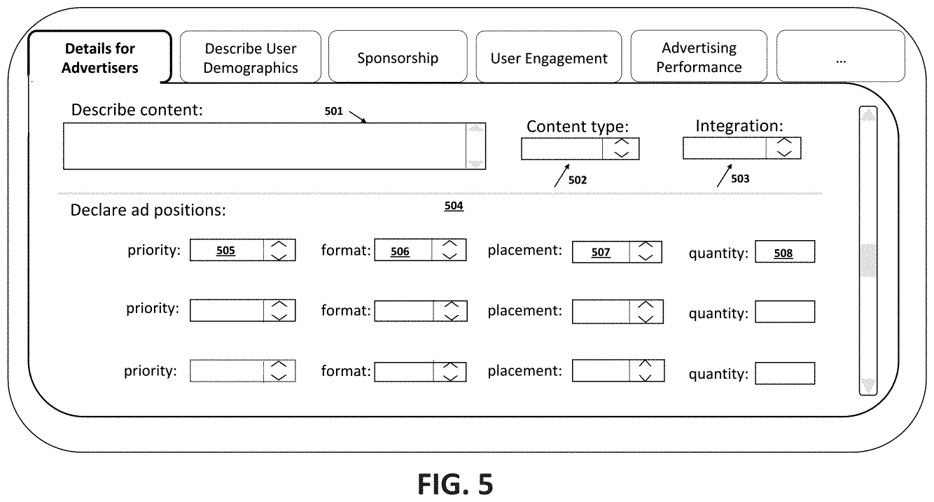

The screen through which a publisher 120 submits to advertisers 130 the details of the content is illustrated in FIG. 5. It includes places to describe the content 501 and indicate the content type 502, if multiple content types are managed. Suitable choices in the “Integration” drop-box 503, limited to the level of integration with the store's monetization framework, may be “none”, “telemetry only”, “advertising only”, or “both”. Bottom part of the screen 504 allows publisher 120 to declare advertisement positions so that advertisers 130 may construct narrowly-targeted campaigns. An advertisement position is defined by its priority, format, placement, and quantity. The priority 505 may be one of “top”, “high”, or “standard”. Advertisement format 506 may be one of “native”, “video”, “audio”, “banner”, or “text”. Placement choices 507 may be “interstitial”, “home”, “detail”, or “other”. The quantity 508 is the number of advertisement slots in the position.

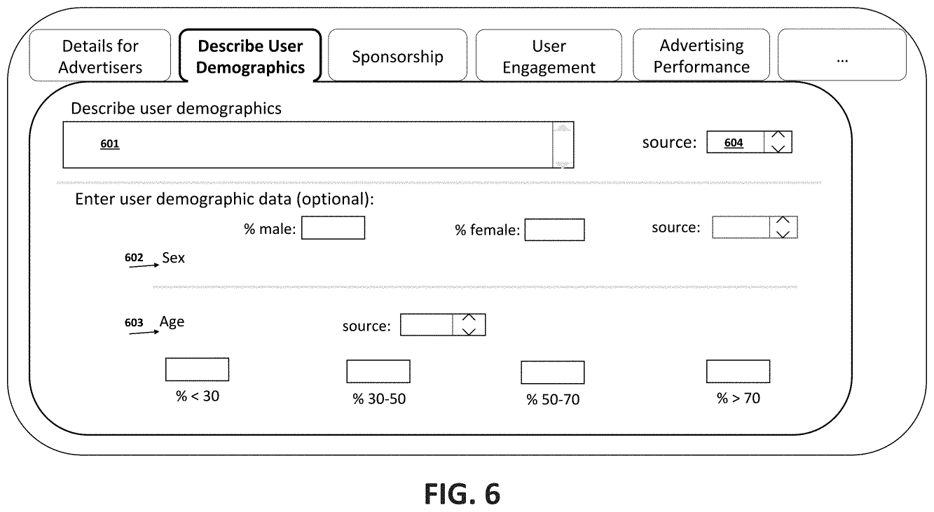

FIG. 6 illustrates a screen that allows publishers 120 to provide information about the demographics of the content's audience 601. In the figure, demographics are restricted to sex 602 and age 603, but they need not be. There are places for publisher 120 to describe the audience demographics in general terms and, optionally, to provide detailed information about the sex and age distribution. Publisher 120 would also declare source of the information 604 which may be a choice of survey, machine learning, or best guess. While the store may obtain demographic data through alternative sources, we continue to assume publisher-supplied demographic data, which is user privacy aware.

The supplied information about user demographics will invariably be presented to advertisers 130 to facilitate their assessment of the appropriateness of a digital content, publisher 120 or content category. The demographic and telemetry information in Advertiser Store 135 may facilitate privacy-mindful approaches to mobile advertising in that they may eliminate the need to decorate bid requests with demographic and behavioral attributes. The fact that publishers 120 do not know in advance who will be reading the information gives them an incentive to make as honest disclosure as possible.

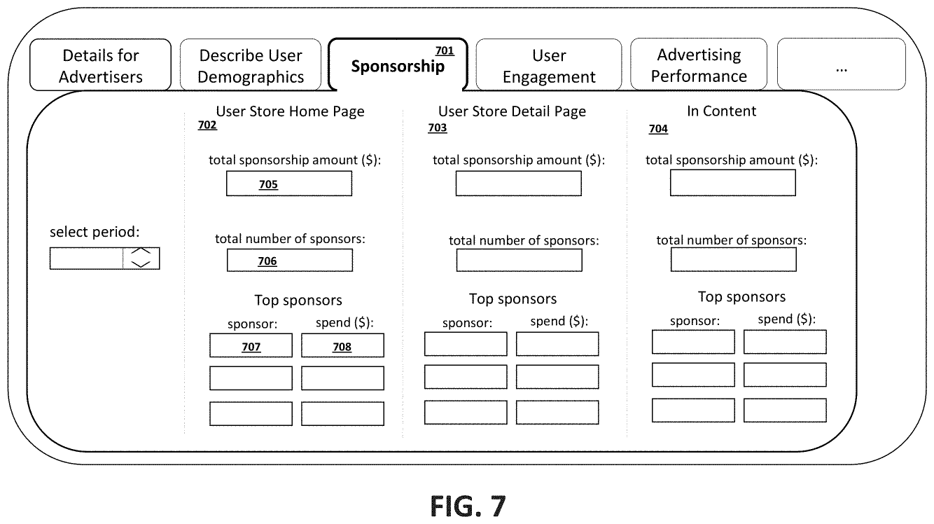

FIG. 7 illustrates a critical screen for the store's internal propulsion, which summarizes sponsorship support 701. The screen may be broken into separate sections for each type of placement for sponsors' ads. In the examples, those placements are User Store 115 home page 702, the content's detail page 703 and the content itself. For digital content, which is not yet integrated with the store's advertising kit 160, the “In Content” section 704 would include only an incentivizing reminder to publisher 120 to integrate the content with the store's advertising kit 160, at which time it may start monetizing the content. The sections summarizing the level of sponsorship 705-708 on User Store 115 home and detail pages give a concrete and alluring incentive to publisher 120 to integrate.

In separate widgets, not shown in FIG. 7, publisher 120 may be reminded: that sponsorship in User Store 115 results from advertiser's 130 desire to establish a relationship with publisher; that sponsorship is a profitable form of premium advertising; that the level of in-content sponsorship may be much higher than in User Store 115; and that additional non-sponsorship advertisements would often keep the fill rates at a reasonable level. With this understanding, publisher 120 who has a content appealing to advertisers 130 is more likely to sense and react to the gravitational power of prospective sponsorship support. The favorable conditions for the store's internal propulsion, which started to manifest in User Store 115, are now being amplified in Publisher Store 125.

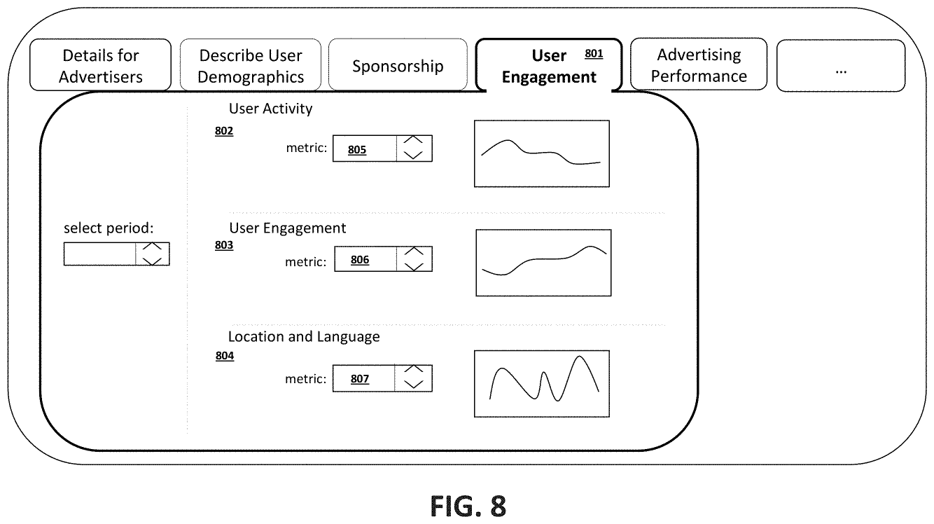

The user-engagement screen is illustrated in FIG. 8. Publishers 120 who had integrated the content with the store's telemetry kit 170 T-SDK may monitor the level of user engagement 801 with the digital content. A publisher 120 who did not integrate should see a recommendation to integrate in order to monitor user engagement and, possibly, gain inventory appreciation from advertisers 130 who will see the same engagement data. When integrating with the store's telemetry kit 170, publisher 120 may be given an option to enable both or only the first benefit or, perhaps, some more granular choices.

Provided only the session information is tracked, the aggregated statistics featured on this screen may include user activity 802, user engagement 803, and the location and language 804 reports. The metrics of the first group 805 may include the number of unique daily or monthly active users tracked over a period. User Engagement metrics 806 may include the number of sessions and average session duration over the same period. The metric choices in the “Location and Language” widget 807 may include the distribution of user or device locations, e.g. country, and language distribution over a given period. Other potentially viable statistics may also be included.

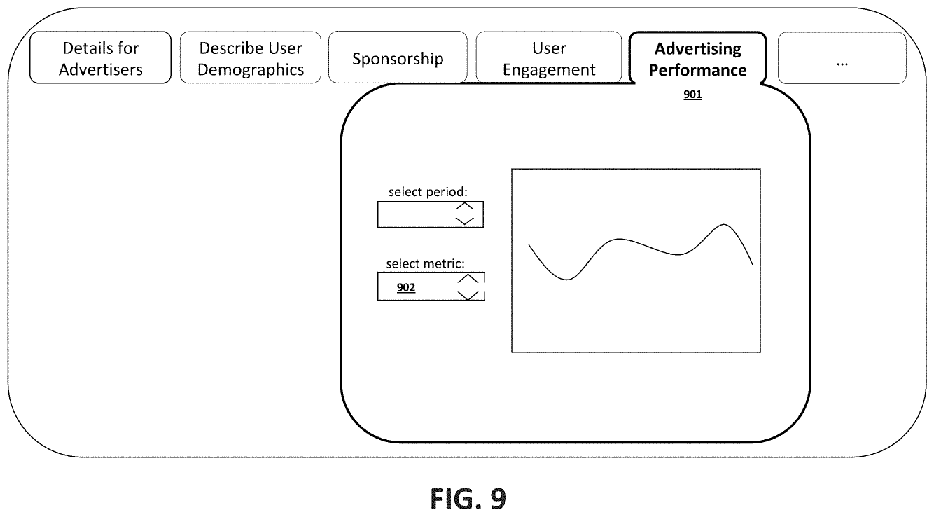

FIG. 9 exemplifies another relevant screen on Publisher Store 125, on which publisher 120 of content integrated with advertising kit 160 would track in-content advertising performance 901, including sponsorship and open auctions. Number of different metrics 902 may be useful here, such as bids, failures to load, impressions, clicks, click-through rate, and fill rate earnings. Those publishers 120 who did not integrate their content with A-SDK would see the same recommendation as on the “Sponsorship” screen FIG. 7.

Advertiser Store 135 must be configured to support browsing and searching, segment definition and inventory forecast, campaign setup, and campaign performance monitoring. The browsing and searching capabilities are similar to those in User Store 115. Unlike User Store 115, Advertiser Store 135 may have three types of detail pages: content, publisher, and content category. Based on these details, sponsors may formulate segments of audience of specific content, publishers 120 or content categories, or a combination of these.

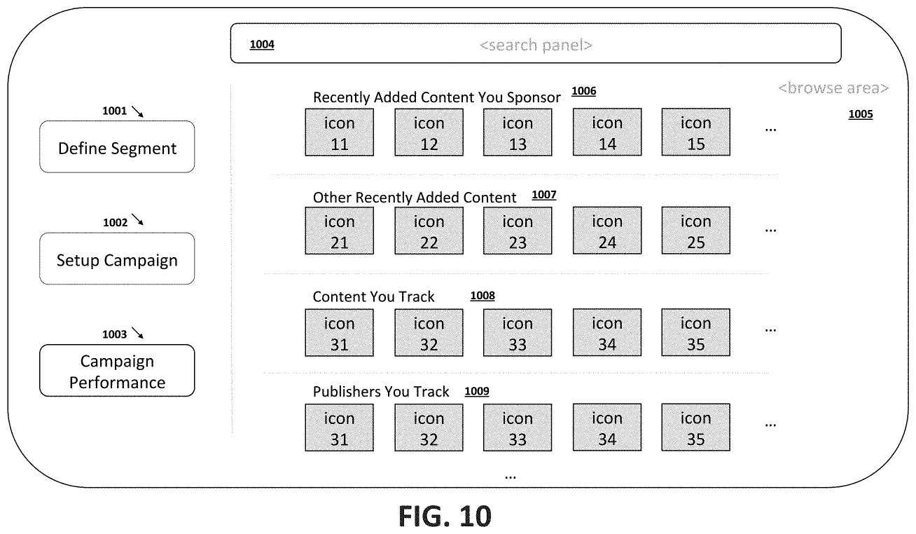

FIG. 10 illustrates advertiser's 130 home page. It includes the buttons that lead advertiser 130 to segment definition 1001, campaign setup 1002, or performance monitoring 1003 screens. Through keyword search 1004, advertisers 130 may locate specific content, publishers 120, or categories. The browse area 1005 includes several racks of content icons. The most important is the top rack 1006, which is presented to sponsors of content that has just integrated with the store's advertising kit 160. As a result, the sponsors are the first to receive the information upon the integration. Capitalizing on the less contested inventory shortly after integration and the guarantees provided by the digital-content sponsorship framework, the sponsor may follow up with an in-content sponsorship campaign. The remaining racks may include recently added content 1007 and separate racks for contents 1008, publishers 1009 and content categories tracked by advertiser 130. Content recommendation for Advertiser Store 135, which is fundamentally different from recommendation in User Store 115, is not required by the inventive method.

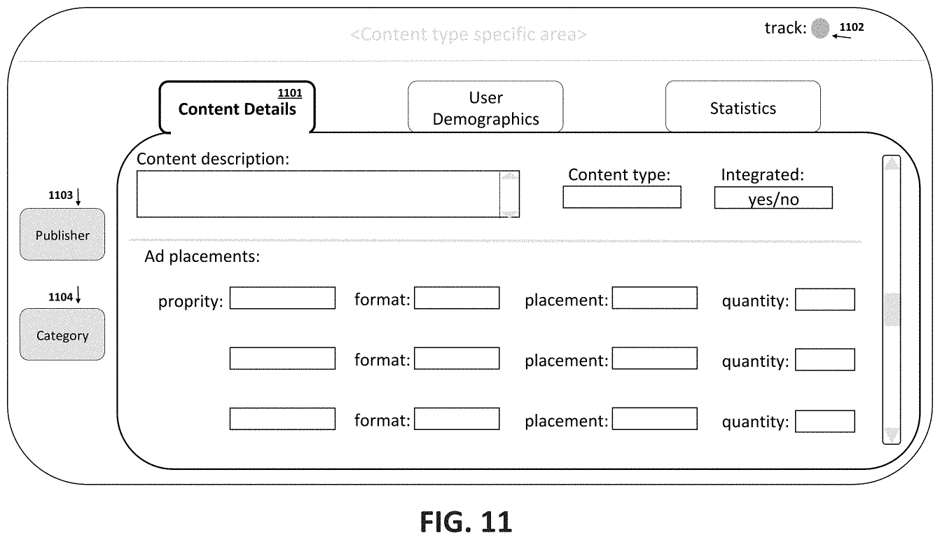

The detail page of a digital content displays publisher-supplied information about the content and aggregated user-telemetry data. For advertisers 130, the important information includes the content details, demographic data, and the user engagement statistics, illustrated in FIGS. 11, 12, and 13, respectively. The information on these screens was discussed in the descriptions of FIGS. 5, 6, and 8. The detail page may also include an indicator whether the content is integrated with the store and a radio button allowing advertiser 130 to track the content 1302.

Provided the content is integrated with the store's telemetry kit 170, advertiser 130 will have necessary insights into the contextual aspects and the aggregated demographic, geographic, and behavioral data in order to assess the appropriateness of a digital content for targeting. Based on this, they may also translate the targeting objectives into a segment definition. Without such integration, publisher 120 is not doing all it may to gain inventory appreciation among potentially interested advertisers 130, and the content's prospects for monetization are diminished. Gaining the appreciation for the content's inventory is publisher's motivation to provide detailed and accurate information and present the engagement statistics on Advertiser Store 135. Since there are significant incentives for publishers 120 to integrate, the digital-content store does not have to require integration with its telemetry and advertising kit 160 170.

As shown in FIG. 11-13, advertiser 130 may go from the content's detail page to the detail page of publisher 1303 or the content's top category 1304 by clicking on the respective button. The details about publisher or category help advertiser 130 assess the suitability of the larger audience for targeting by observing the trends in user engagement as well as geographic and language distribution. For some types of digital content, such as video or electronic books, aggregate audience across the content of a publisher or category may be more appropriate than a fragmented audience of individual video or books. The engagement data across publisher or category may be obtained by aggregating the data of telemetry-integrated contents of publisher or category, respectively.

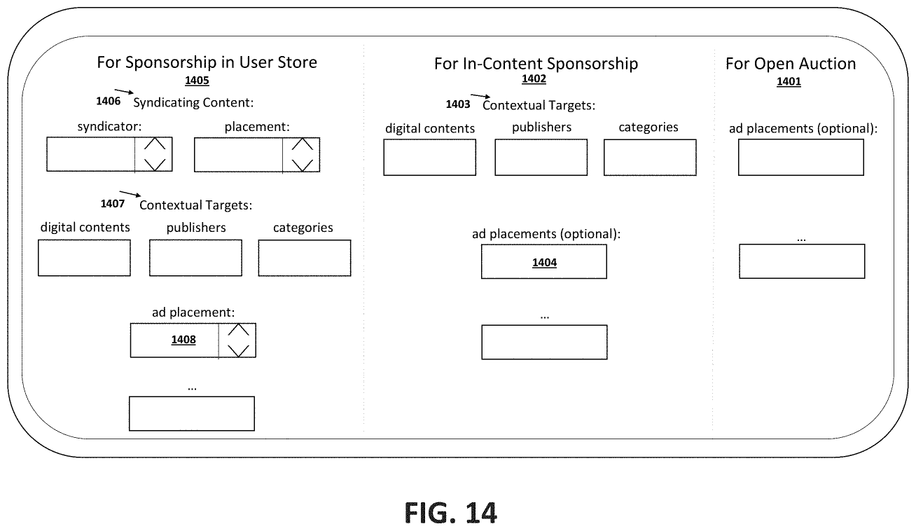

Through the segment-definition screen, an advertiser 130 may define a segment for open auction, in-content sponsorship, or content sponsorship in User Store 115. In FIG. 14, these variants appear right-to-left. Segment definition for open auction 1401 may reuse the screens and corresponding processes of the underlying advertising platform. Depending on the platform, this typically includes the definition of contextual targets and the desirable user geographic, demographic, or behavioral indicators. For the definition of open-auction segments, none of these elements is mandatory. A segment may qualify for in-content sponsorship 1402 only if the contextual target is specified 1403. The contextual target of a sponsorship segment may be the ID of the targeted content, publisher, or category, or a set of identifiers defining any combination of these. As show in the center column of FIG. 14, advertiser 130 may optionally restrict advertisement placements in the targeted contents 1404. User Store 115 may be a contextual target of in-content sponsorship segments.

A segment for content sponsorship in User Store 115 1405 must differentiate the syndicator, e.g. User Store 115 1406, from the sponsored content. The advertisements will appear on the designated places of the syndicator's content, but their intent is to indicate support for content distributed by User Store 115. As before, the “contextual target” 1407, i.e. the digital content that is sponsored, is the ID of a targeted content, publisher, or category, or a set of these. The final aspect of this segment definition process is the selection of the advertisement placement 1408. With the earlier examples related to User Store 115, the choices are home or detail page. The selection of the syndicator, sponsorship target, and the advertisement placements are mandatory parts of the segment definition for content sponsorship in User Store 115. There are no fundamental changes in the inventive method if the digital-content store has more than just User Store 115 as the syndicator. For this variant of segment definition, the inventory forecasting framework may be modified to account for the frequency of exposure of a digital content on User Store 115 home page or the frequency of access to a detail page.

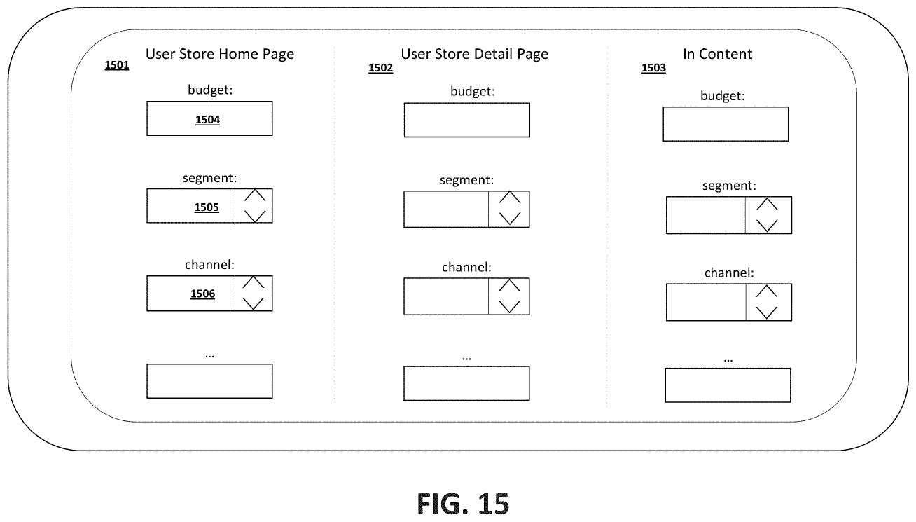

FIG. 15 is an example of the screen for the setup of a sponsorship campaign. The setup may require advertiser 130 to specify separate campaign budget 1504 for sponsorship advertisements on User Store 115 home page 1501, content details pages 1502, and in-content 1503 sponsorship ads. The segments 1505 selected for each section must satisfy the restrictions for User Store 115 or in-content segment definition. When multiple premium channels are available, sponsor must select appropriate channel for the ads. For sponsorship in User Store 115, the only viable channels are programmatic settled and restricted. For in-content sponsorship, in addition to these, the guaranteed deals are also available. The remaining section of the sponsorship campaign setup is specific to the underlying advertising platform. Campaign setup for open auctions may reuse the same process for the underlying advertising platform.

Clicking on “Campaign Performance” 1003 on advertiser 130 home page FIG. 10 brings advertiser 130 to a campaign selection screen. For a selected campaign, the corresponding screen would display the usual campaign metrics, e.g. the number of bids, wins, failures to load ads, impressions, clicks, click-through rate, advertisement spending, etc. Another screen may provide aggregated statistics across all campaigns of advertiser 130.

Advertisers 130 generate several critical events for the automated propulsion of the store. First, by investing into sponsorship on User Store 115, an advertiser 130 may help draw new publishers 120 to integrate their digital content with advertising kit 160. Advertiser's 130 incentives to pursue such sponsorship include: the marketing message is displayed on premium content of User Store 115; the advertisements blend well into the main mission of the content; advertiser 130 achieves a gradual amplification of the marketing message as the user goes through the store into a sponsored content; advertiser 130 gets early notifications with first-priority treatment when the content becomes available.

Second, as soon as the digital content is integrated, the marketer may follow up with an in-content sponsorship campaign, ensuring the content begins early monetization through premium channels. Advertiser's 130 incentive to do so is a potentially higher return on investment just after the sponsored content integrates with the store's advertising kit 160.

Third, by investing into in-content sponsorship, advertiser 130 increases the loyalty of existing customers and helps keep the store's premium demand at a satisfactory level. This is naturally incentivized by the priority and visibility that sponsorship advertisements get, which may lead to a high marketing impact of such ads.

Fourth, by investing into open auctions, advertiser 130 helps keep fill rates in available digital content at a high level. Advertiser's 130 incentive for this type of event is the opportunity to reduce the cost of advertisements by taking on some risks of lowering the visibility of advertisements and marketing impact.

Fifth, through the engagement in the monetization framework of the store, advertiser 130 helps build critical level of interest into available supply that keeps the process of inventory appreciation going. A high-quality replenishing supply brought into the store on and by advertising demand makes sure that the store sees many events of this type. Further, explicit incentives may be triggered automatically if the store has automated incentives engine and the engine detects an underrepresentation of certain events.

Internal System Events

The most important system events for the inventive method include content-description, telemetry, bid request, bid response, and reporting events. Their description uses the terminology of and builds on the IAP OpenRTB 2.5 Specification. In particular, the events of bid request and bid response are derivatives from the respective events defined in the specification, with some additions that are emphasized below. Since not all terms will be explained, the reader should refer to OpenRTB 2.5 Specification for their meaning.

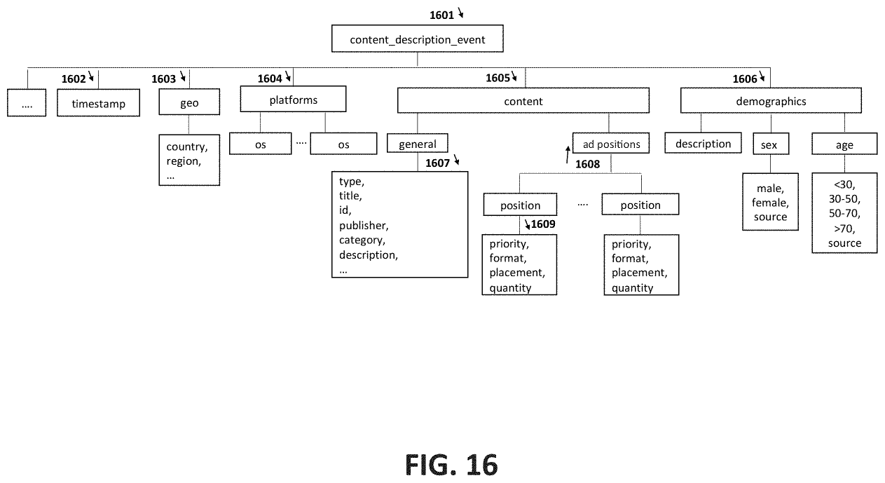

FIG. 16 illustrates the structure of a content-description event 1601 generated through Publisher Store 125 whenever publisher 120 creates or modifies the information about the content or user demographics. The information is generated through the “Details for Advertisers 130” FIG. 5 and “Describe User Demographics” FIG. 6 screens in Publisher Store 125. The event may include: timestamp 1602; geographic location of publisher 1603; the supported platforms 1604, i.e. the operating systems “os” to which the digital content is ported; the information about the content and its advertisement placements 1605; and an object describing user demographics 1606. The “content” object may maintain general information about the digital content, which may include: content type, content title, content's ID, the object of publisher, content category, and publisher-supplied description 1607. Each advertisement position 1608 may include FIG. 5: the ad-placement priority, advertisement format, position, and the number of advertisement slots in the position 1609. The “demographics” object may include a description of the sex and age distribution provided by publisher 120 FIG. 6. The content-description events are presented to advertisers 130 on the detail pages in Advertiser Store 135.

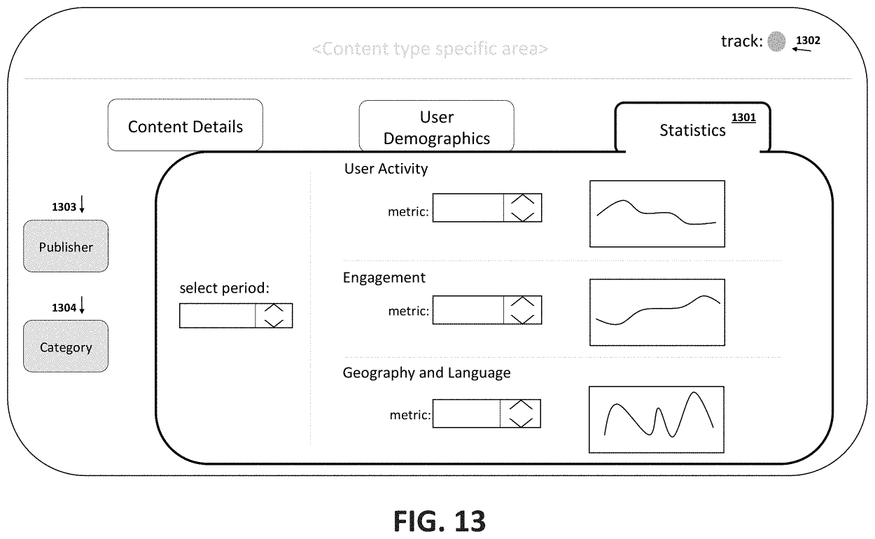

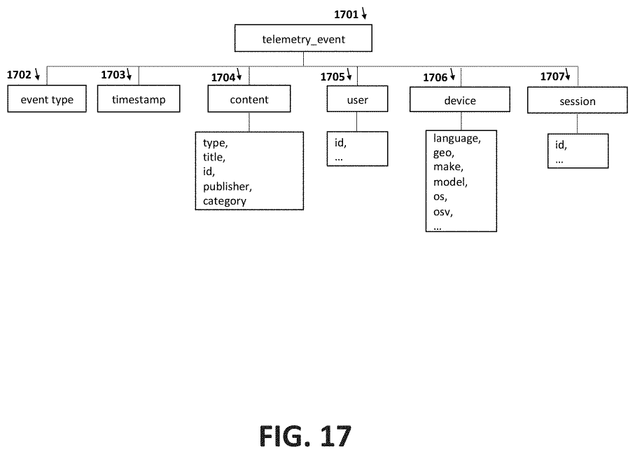

FIG. 17 illustrates, by way of example, the structure of a telemetry event 1701 appropriate for the inventive method. The examples of content-description and telemetry events assume that a digital content belongs to a single category. The event may include: event type 1702, event date-time 1703, content descriptor 1704, and the objects summarizing the information about the user 1705, device 1706, and session 1707. For the purposes of the invention, the event type 1702 may be restricted to session start, stop, pause or resume. The “content” 1704 object may include: the content type, title, content id, publisher objects, and the content's category. The only relevant piece of information in the “user” object 1705 is the unique user id, which may be a resettable Advertising ID. The “device” 1706 object is the same as in the OpenRTB 2.5 Specification. Session id is the only relevant field of the “session” 1707 object. From the telemetry events, Telemetry Reporting component 155 may produce aggregated statistics about user engagement displayed in both publisher 120 and advertiser Store 135 fronts, FIGS. 8 and 13, respectively.

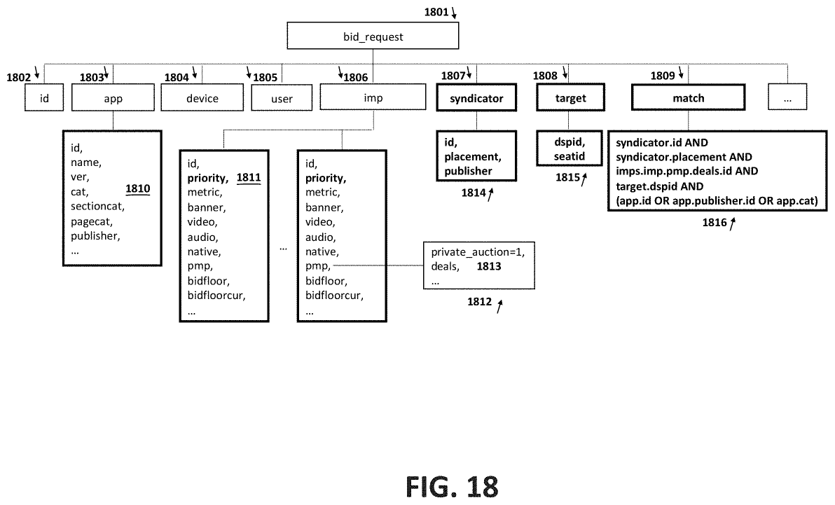

Bid request event 1801, illustrated in FIG. 18, is generated by supply-side platform 151 after receiving an advertisement call through the store's advertising kit 160 from a digital content or User Store 115. The event is submitted in real time to native demand-side platform 157 and, except for sponsorship requests originating in User Store 115, to external demand-side platforms 158. The additional fields, which do not exist in the corresponding event of the OpenRTB 2.5 Specification, are highlighted in the figure with a bold font or bolder boxes. The additional objects are included for the purposes of in-content or User Store 115 sponsorship. The “extension” object, called “ext” in the OpenRTB 2.5 bid request, provides appropriate place for the additional objects. The familiar objects of the OpenRTB 2.5 specification include id 1802, app 1803, device 1804, user 1805, impression 1806, pmp private marketplace 1813, and deals 1814. Here, “app” means digital content. In the “app” object 1803, the field “cat” 1810 maintains a list of categories describing the content. The new field “priority” 1811 in the “impression” object 1806 describes the priority of the advertisement impression in the digital content, which may be “top”, “high”, or “standard”. This field may optionally be used by the demand-side platforms to determine whether and how much to bid. Other fields of the OpenRTB 2.5 bid request are also applicable here.

The additional descriptors of a bid request include syndicator 1807, target 1808, and match conditions 1809. They are used to solicit bids for sponsorship in User Store 115 or in a digital content. Assuming that User Store 115 is the only syndicator in the store, the “id” 1817 of the “syndicator” object 1807 stores the identifier of User Store 115. In the examples, the placement 1814 is “home” or “detail”. Publisher 120 1814 is the store itself. The “target” object 1808 directs bids to a single demand-side platform or to a demand seat of advertisers 130. For sponsorship in User Store 115, target DSP ID 1815 stores the id of native demand-side platform 157. For in-content sponsorship, the target may either be native demand source or omitted, in which case any demand-side platform may submit the sponsorship bids. The “match” object 1809 specifies the conditions to be matched for a bid to qualify for sponsorship. For content sponsorship in User Store 115, these conditions include 1816: syndicator id, advertisement placements in the syndicator, Deal ID, DSP ID, and one of content, publisher, or category ID. For in-content sponsorship, syndicator id and placement are omitted and DSP ID is optional. The bidder must match one of the Deal IDs as well as the content, publisher 120 or a category.

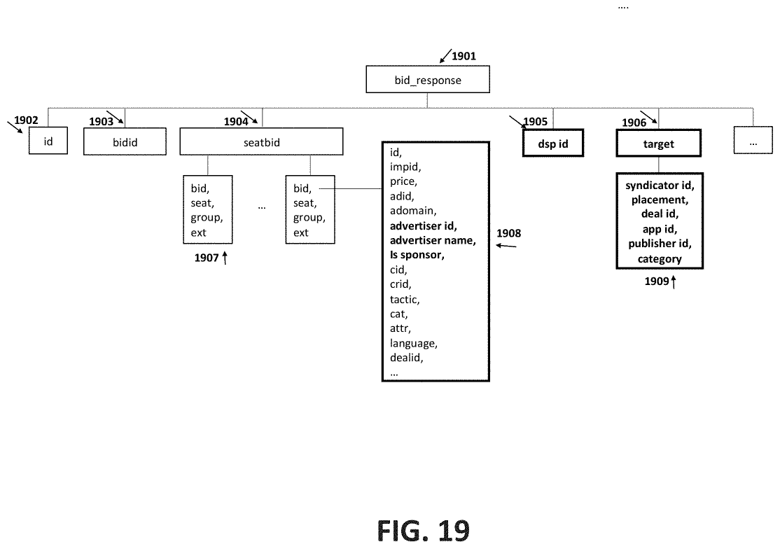

FIG. 19 describes the structure of a bid response 1901 sent by a bidding platform to supply-side platform 151. As in the bid-request structure FIG. 18, all fields of the OpenRTB 2.5 bid response structure are applicable here. The figure shows only the most important fields: id 1902, bid id 1903 and the array of seat bid objects 1904 with bids 1907 of potentially more than one demand seat. As in OpenRTB 2.5, if multiple impressions are given in the request, “group” 1907 specifies if a seat is willing to accept any impressions it may win or wants to win or lose them as a group. The structure of a bid 1908 has advertiser 130 id and, optionally, name as additional fields. An indicator whether the bid is for a sponsorship advertisement 1908 is also present. The additional objects include the fields used by supply-side platform 151 to verify that the match conditions for a sponsorship advertisement impression are satisfied. They include: the DSP ID 1905 and the object called “target” 1906. The latter object optionally includes syndicator id, syndicator placement, Deal ID, Content ID, Publisher 120 ID and the targeted content category 1809. Depending whether the bids are for sponsorship impressions in User Store 115 or in the content, the first two fields are included or omitted, respectively. Only one of Content ID, Publisher 120 ID, and category must be supplied in a bid for sponsorship. Deal ID, which is automatically created for a channel of the private marketplace, is mandatory for all sponsorship bids.

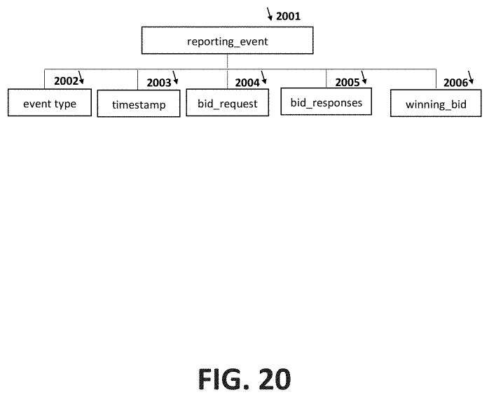

A single structure, shown in FIG. 20, may represent reporting events 2001 for publisher 120 and advertiser 130 insights into advertising performance. Other than the event type 2002 and date-time 2003, the structure combines the events of bid requests 2004 and the corresponding responses 2005. It also includes details of the winning bid 2006 in a separate object. The event type 2002 may represent any real-time bidding event, e.g. the serve bid request, impression, or click. From these events, aggregated statistics are derived based on which publishers 120 and advertisers 130 may assess the monetization effectiveness of the premium and open-auction channels.

Digital-Content Sponsorship Platform

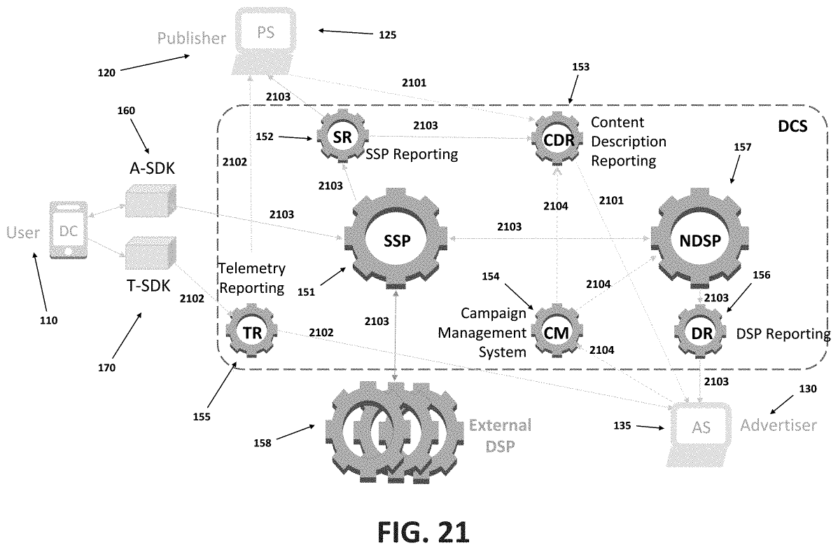

Main components of the digital-content sponsorship DCS platform relevant to the inventive method are, by way of example, shown in FIG. 21. The DCS platform represents the advertising infrastructure of a digital-content store with the programmatic propulsion based on the inventive method. The infrastructure includes a supply-side platform 151 SSP and a native demand-side platform 157 NDSP. Supply-side platform 151 receives calls from advertiser 130 kit and submits bids for impressions in digital contents integrated with the store's advertising kit 160. This also includes User Store 115. Native demand-side platform is a predictive system for programmatic bidding, which submits bids for programmatic-direct sponsorship and open auctions. It manages the campaigns configured through the digital-content store. For high fill rates of in-content placements, supply-side platform 151 may solicit open-auction bids from external demand-side platforms 158 too. The examples and description below assume that the IAB Open RTB specification is the communication protocol between the supply-side 151 and demand-side platforms 157 158.

Reporting infrastructure of the digital-content sponsorship platform has four main components, shown in FIG. 21. The primary function of SSP Reporting 152 SR is to produce reports for the “Sponsorship” FIG. 7 and “Advertising Performance” FIG. 9 insights in Publisher Store 125. This component, taking input events from supply-side platform 151, also participates in the flow of processing that feeds certain insights in Advertiser Store 135. The purpose of DSP reporting 156 DR is to generate statistics for the “Campaign Performance” insights in Advertiser Store 135 based on the events produced or received by native demand-side platform 157. Content-Description Reporting component 153 CDR feeds the following information in Advertiser Store 135: parts of advertiser's 130 home page; the content, publisher, and category descriptions; and user demographic insights. Other than the content-description events from Publisher Store 125, this component takes as input certain events produced by the SSP Reporting 152 and Campaign Manager 154 CM. Telemetry Reporting component 155 TR, which receives events from the store's telemetry kit 170, feeds the user-engagement statistics in the detail pages of publisher and Advertiser Store 125 135 fronts. Campaign Manager 154 handles the segments and campaigns defined by advertisers 130. The data maintained by this component is used by native demand-side platform 157.

Primary flows of processing in the digital-content sponsorship platform are: content description 2101, user telemetry 2102, real-time bidding 2103, and campaign management 2104 flows.

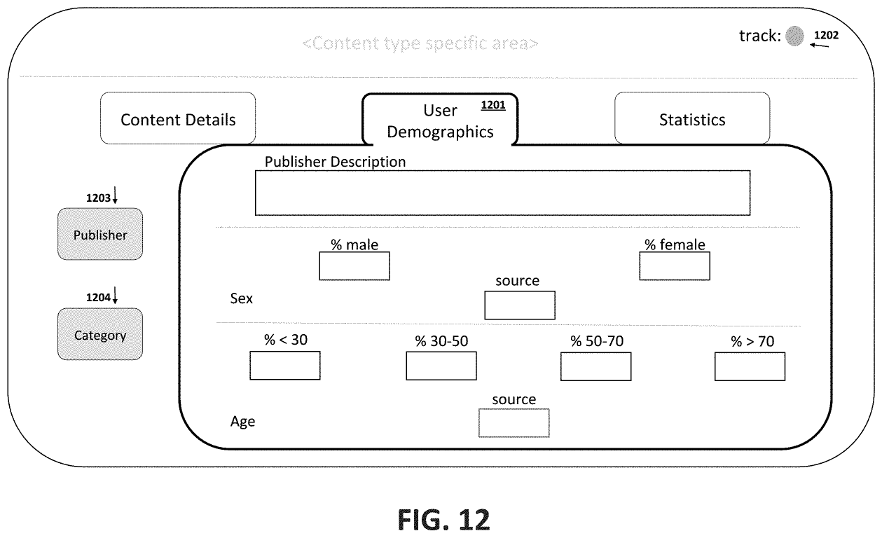

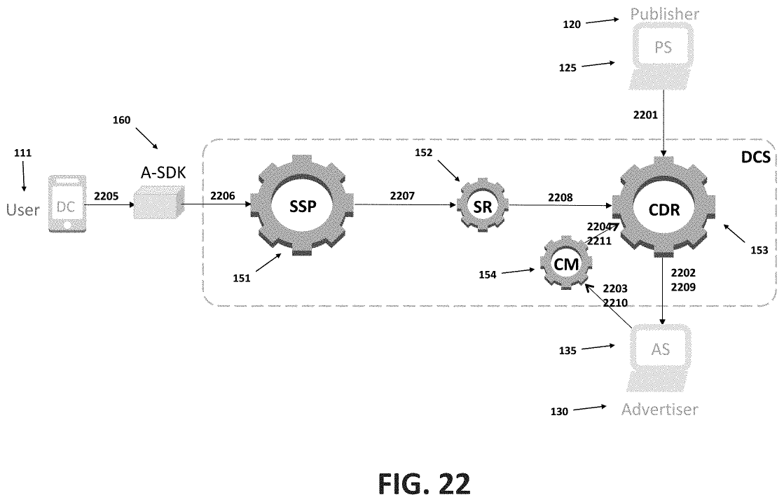

FIG. 22 gives a high-level representation of a pipeline that propagates the content or publisher description events from Publisher 120 to Advertiser Store 135. This pipeline contains mechanisms that power important aspects of the inventive propulsion method. Both new and updated content-description events FIG. 16 generated in Publisher Store 125 are submitted to Content-Description Reporting component 153 at Link 2201. The system stores them as raw events in an internal database, from which they may be displayed in Advertiser Store 135 at Link 2202 whenever the marketer comes to the details FIG. 11 or demographics FIG. 12 screen of a detail page.

Of special interest is the scenario when a campaign targets in User Store 115 digital content that has not been integrated with the store's advertising kit 160 at Link 2203. Campaign Manager 154, which prepares campaign metadata for native demand-side platform 157, plays a role in the content-description process too. In this scenario, Campaign Manager 154 updates a special “affinity table” in the database of Content-Description Reporting component 153, adding the association between advertiser 130 and the digital content and setting its status to “pending” at Link 2204. If advertiser's 130 campaign targets a publisher, one such record is inserted into the affinity table for each digital product of publisher. A different table of the content-description database would contain a list of publisher's digital contents.

SSP Reporting 152 also participates in the content-description process by updating the <content, advertiser 130>associations in the affinity table whenever a new digital content is integrated with the store's advertising framework. At that time, the events of the newly integrated content start flowing from the digital content to supply-side platform 151 at Links 2205, 2206. Periodically, these events are collected at Link 2207 and processed by SSP Reporting 152, which sets the status field in all affinity records belonging to the digital content to “activated” at Link 2208. The activated associations will be presented to advertiser 130 at the top rack of the home-page browsing area in Advertiser Store 135 at Link 2209, serving as a reminder and incentive to advertiser 130 to follow up with an in-content sponsorship campaign. As soon as advertiser 130 does so at Link 2210, Campaign Manager 154 deletes the corresponding <content, advertiser 130>association from the affinity table at Link 2211.

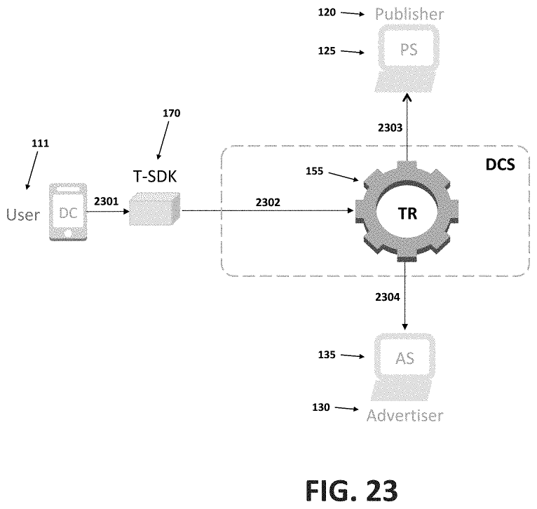

The process of Telemetry Reporting component 155 is diagrammed in FIG. 23. Through telemetry kit 170, telemetry events FIG. 17 are submitted to Telemetry Reporting component 155 at Link 2301, which aggregates the data on date, digital content, publisher, and category to produce the user activity, engagement, location and language statistics. The aggregated data is stored in a database internal to Telemetry Reporting component 155 at Link 2302. The console of publisher 120 at Link 2303 or Advertiser Store 135 at Link 2304 queries this database on demand in order to render an engagement report to publisher 120 or advertiser 130, respectively. The reports are displayed on the screens of the two store fronts shown in FIGS. 8 and 13.

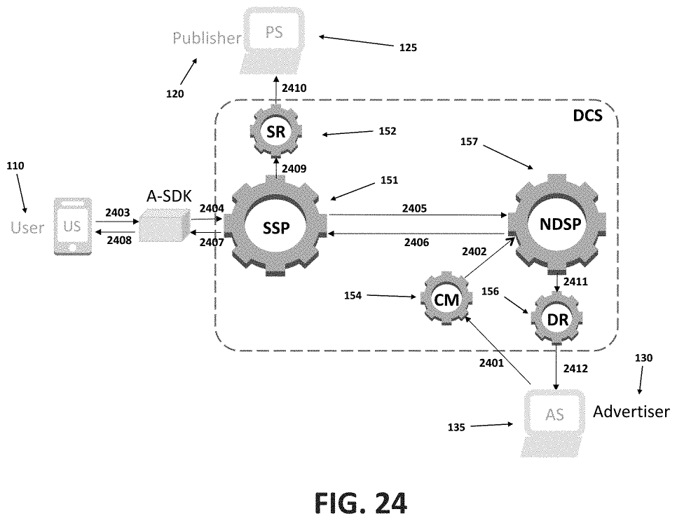

FIG. 24 illustrates, by way of example, the process of real-time bidding for digital-content sponsorship advertisements in User Store 115. The first flow in the figure is initiated by an advertiser 130 who submits a sponsorship campaign targeting the advertisement placements in this store front at Link 2401. The campaign and segment definitions are materially embodied in the database by the Campaign Manager 154 at Link 2402. When a user comes to a place in User Store 115 designated for sponsorship ads, this store front initiates an ad-call request through advertising kit 160 at Link 2403. The request is forwarded to supply-side platform 151 at Link 2404 of the digital-content sponsorship framework. Supply-side platform 151 creates a bid request object of FIG. 18 and sends it to native demand-side platform 157 at Link 2405. The bid request includes the syndicator, target, and match descriptors shown in FIG. 18. For content sponsorship on User Store 115, external demand-side platforms 158 are not consulted.

If there is a sponsorship campaign targeting one of the digital contents referenced in the bid request, and the match criteria are satisfied, native demand-side platform 157 attaches the appropriate bid to the bid-response event of FIG. 19. The bid must include the “is sponsor” flag set to true, advertiser 130 id and, optionally, advertiser 130 name. Separate bids may be submitted for different demand seats. With the appropriate bids attached, native demand platform sends the bid response back to supply-side platform 151 at Link 2406. Upon verifying that match criteria are satisfied; supply-side platform 151 notifies native demand-side platform 157 of the wins and losses. Then it informs advertiser 130 kit of the winning bids, attaching the attributes of the creative at Link 2407. Advertiser 130 kit typically communicates with an advertisement server in order to render the sponsorship messages or advertisements at Link 2408.

Supply-side platform 151 forwards the reply to advertiser 130 kit at Link 2407, generating a reporting event of FIG. 20 at Link 2409. Subsequent advertisement events, e.g. failures to render an ad, impression or click, may also be communicated through advertiser 130 kit to supply-side platform 151, which would then generate an appropriate reporting event. The user interactions are recorded in clickstream logs, which may be, eagerly or lazily, transported to SSP Reporting 152. The SSP Reporting 152 element will, hourly or daily, preprocess, decorate, join, and aggregate the reporting events, producing reporting feeds for the sponsorship FIG. 7 and advertising performance FIG. 9 screens on Publisher Store 125. The feeds may be used to update an internal database of SSP Reporting 152, which may be queried on demand by the console of Publisher Store 125 to display appropriate reports to a publisher 120 at Link 2510.

Events generated or received by native demand-side platform 157 are also converted to reporting events at Link 2411. Every hour or day, the DSP Reporting component 156 pre-processes, joins, and aggregates the events, producing a reporting feed for the advertising-performance insights in Advertiser Store 135. The feed is used to update a database of DSP Reporting component 156, which may be queried by Advertiser Store 135 to render the requested statistics to an advertiser 130 at Link 2412.

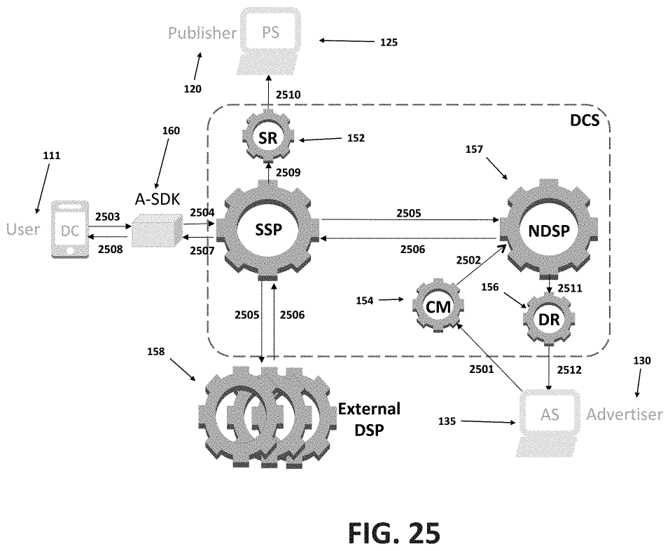

The bidding process for in-content sponsorship or open-action advertisements is illustrated by the diagram of FIG. 25. Assuming, for simplicity, that in-content sponsorship advertisements may only come from native demand-side platform 157, native demand-side platform 157 may submit both sponsorship and open-auction bids, whereas external demand-side platforms 158 may participate in open auctions only. An advertiser 130 of native demand-side platform 157 creates a targeting campaign at Link 2501. Campaign Manager 154 stores the campaign and segment definitions in a database at Link 2502. When an advertisement call is sent from the content at Link 2503 through advertising kit 160 at Link 2504, supply-side platform 151 creates a bid request and sends it to native demand-side platforms 157 and external demand-side platforms 158 at Link 2505. For bidding on a programmatic-direct channel, the bid request would include the target and match conditions. For in-content sponsorship, the syndicator object is omitted, and the match conditions need not include the syndicator id and placement fields.

For a sponsorship campaign targeting impressions in the request, when the match criteria are satisfied, native demand platform attaches appropriate bid to the bid response event of FIG. 19. As before, the bid includes the “is sponsor” flag set to true and advertiser 130 ID. Whether or not there are appropriate sponsorship bids, native demand-side platform 157 may bid at any level of the private marketplace on behalf of potentially more than one demand seat. With the appropriate bids attached, native demand-side platform 157 sends the bid response back to supply-side platform 151 at Link 2506. After receiving bids from demand sources and verifying that the match criteria for sponsorship impressions are satisfied, supply-side platform 151 decides the winners and notifies the demand-side platforms of the wins and losses. It then sends the winning bids with creative attributes to advertiser kit 160 at Link 2507, which, in turn, renders the sponsorship advertisements after consulting the advertisement server at Link 2508.

The reporting processes for in-content bidding at Links 2509-2512 are the same as in real-time bidding for User Store 115 inventory. So is the infrastructure that powers the processes. The described reporting components may employ a streaming pipeline and one or more databases or data warehouses. The streaming pipeline may be built on a suitable software system, which may be any proprietary streaming technology or open-source software such as Apache Hadoop, Spark, Storm, or Flink. The internal databases may be either relational, NoSQL, or NewSQL systems. The warehouses for consolidated or aggregated data may be powered though one or more software systems, which may range from simpler warehousing software to sophisticated business-intelligence systems available today or in the future. A software system is a collection of programs implemented for execution on programmable computer systems.

The described processes may be carried out by a computational infrastructure that includes: front-end components, such as a desktop computer or mobile device with a graphical user interface or an Internet browser; back-end components, e.g. data servers; and middleware components, e.g. application or Internet servers, which perform mediation between front-end and back-end components. These computer systems may be organized as client/server or widely-distributed systems. The clients and servers may be geographically dislocated from each other, interacting through any digital data-communication medium, commonly referred to as a computer network. Examples of such networks include LAN, WAN, the Internet, and wireless networks.

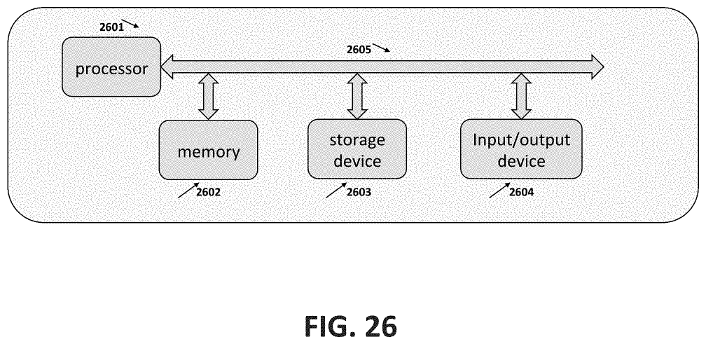

The system's processes may be implemented as programs running on generic or special-purpose computer systems, e.g. the one illustrated in FIG. 26. The processes may be implemented in digital electronic circuitry, or in computer hardware, firmware, software, or their combination. The steps of the described processes may be performed by a programmable processor 2601 executing instructions that operate on input data and produce output data. The described processes may be implemented as software systems consisting of one or more computer programs.

A computer program represents a set of instructions that perform an activity. The program may be written in any compiled or interpreted programming language. These activities may be implemented in stand-alone programs or in component, module, subroutine, or other machine-executable unit. Suitable computers for the execution of a program of instructions include one or more processors, each of which may be a general or special-purpose processor. A processor receives instructions and data from a read-only or random-access memory or both.

The essential elements of a computer system are one or more processors 2601 for executing instructions, one or more internal volatile or non-volatile memories 2602 for storing instructions and their data, one or more mass storage devices 2603, and one or more input/output devices 2604. The components are interconnected via a system bus 2605. The processor is capable of processing instructions stored in memory or a storage device to produce graphical displays for a user interface that may be presented on a suitable input/output device. A processor 2701 may be a single- or multi-threaded one. The memory 2602, which stores data within the system, may be volatile or non-volatile.

A computer is, generally, operatively coupled with internal or external devices 2603 for mass storage of data in data files. Suitable storage devices for persistently storing data and instructions of a computer program in files may be any form of non-volatile memory or a combination of such memories. These may include semiconductor memory devices, such as EPROM, EEPROM, solid-state or flush-memory drives, hard or removable magnetic disks, optical or magnetic optical disks, or magnetic tapes. The removable storage devices may be based on a CD-ROM or DVD-ROM technology. An input/output device 2604 provides a medium for carrying input/output operations. Examples include a keyboard, a pointing device, e.g. a mouse, a trackball, or a terminal for displaying graphical interfaces to the user. A terminal device may be a liquid crystal display LCD or cathode ray tube CRT monitor. The elements of a computer system may be implemented as generic or application-specific integrated circuits.

Steps of the Inventive Method

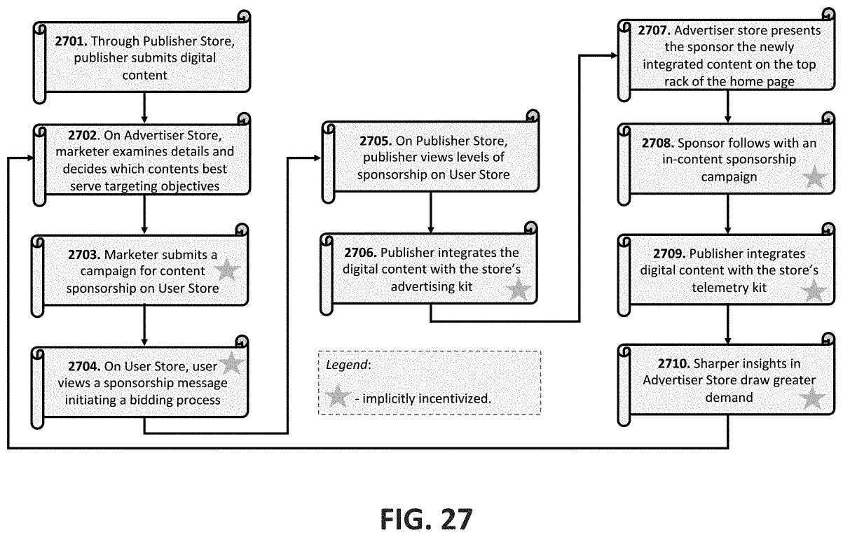

With the above processes and systems, the steps of the inventive method for programmatic propulsion of self-service stores for monetization of digital contents through advertising, as illustrated in FIG. 27, are as follows:

At step 2701, through Publisher Store 125, publisher 120 submits digital content and provides or updates the details for advertisers 130 FIG. 5 as well as the user-demographic description FIG. 6.

The corresponding content-description event FIG. 16 is sent to the Content-Description Reporting component 153 at Link 2201, which stores it as a raw event in its database. Since publisher 120 does not know in advance which marketers will be reading the details and what their targeting objectives might be, publisher 120 has an incentive to provide as accurate description of the digital content and the demographics of its audience as possible. As a result, advertisers 130 may have a fairly high degree of confidence in the provided information. Everything else is automatically recorded by the system. At the time of submission, publisher 120 may or may not elect to integrate the digital content with the store's advertising or telemetry software development kits 160 170.

At step 2702, when an advertiser 130 comes to the details FIG. 11 or demographics FIG. 12 screen of a detail page in Advertiser Store 135, the console of this store front interacts with the content-description database in order to fetch the detail or demographics descriptions, respectively, and display them at Link 2202.

Using views or searches on Advertiser Store 135, the marketers examine the details of digital contents, publishers 120 and categories, determining the contents whose audience best serves targeting objectives. In the early evolution of the store, there may not be many opportunities for in-content advertising and not all relevant details may be available in Advertiser Store 135. In traditional advertising environments, this would usually turn the marketer away. In contrast, digital-content sponsorship may retain the marketer with the implicit incentives to invest in sponsorship on User Store 115.

At step 2703, an advertiser 130 creates segments FIG. 14 for content sponsorship in User Store 115, in-content sponsorship and/or open auction, linking them to a campaign definition FIG. 15 and submitting the advertisement campaign.

Campaign and segment definitions, stored in the database of the Campaign Manager 154 at Link 2401 and at Link 2501, are used by native demand-side platform 157 as metadata for programmatic bidding. If the campaign targets a digital content in User Store 115 that has not yet been integrated with the store's advertising kit 160, Campaign Manager 154 updates the affinity table of the content-description database, adding the association between advertiser 130 and content and setting its status to “pending” at Link 2402. If advertiser's 130 campaign targets a publisher, one such record is inserted into the affinity table for each digital content of publisher.

Sponsorship campaigns in User Store 115 are incentivized by the fact that advertisements will be shown in premium placements of premium content of User Store 115 and by the sponsor's ability to draw digital content with the right audience into the store's sponsorship framework. The marketing message displayed on User Store 115 blends well into the mission of the store front. Advertiser 130 may achieve a gradual amplification of the message as user goes through the store into the sponsored content. The marketer has an incentive to lure publisher 120 into the sponsorship framework because, as soon as publisher's content is integrated, advertiser 130 receives an advance notice and a premier treatment with guarantees through a programmatic-direct channel.

At step 2704, when a user 110 comes to a place in User Store 115 designated for sponsorship ads, e.g. the home page or the Sponsors widget on a detail page, the bidding process takes place. The resulting impressions of sponsored icons or advertisements are recorded by SSP Reporting 152.

User Store 115 initiates the bidding process by submitting an ad-call request through the store's advertising kit 160 at Link 2403, which forwards the request to supply-side platform 151 at Link 2404. Supply-side platform 151 creates a bid request with the “target” and “match” objects shown in FIG. 18 and sends it to native demand-side platform 157 at Link 2405. Whenever there is a sponsorship campaign targeting the digital content, and the criteria specified in the match object are satisfied, native demand-side platform 157 attaches an appropriate bid to the bid response event FIG. 19. With the appropriate bids attached, native demand-side platform 157 sends the bid response to supply-side platform 151 at Link 2406. Upon verifying that the match criteria are satisfied, supply-side platform 151 notifies native demand-side platform 157 about the winners. It also informs advertising kit 160 of the winning bids at Link 2407, which in turn renders the sponsorship messages or advertisements at Link 2408.

Upon delivering the decision, supply-side platform 151 also generates a “serve” reporting event at Link 2409 describing the auction. Through advertising kit 160, subsequent user interactions with the ads, e.g. impressions and clicks, are communicated to supply-side platform 151, which, in turn, generates the corresponding reporting events of FIG. 20. The user-generated interactions are recorded in clickstream logs, which are transported to SSP Reporting component 152. Periodically, the latter component pre-processes, decorates, joins, and aggregates the reporting events, producing the reporting feeds for the sponsorship FIG. 7 and advertising performance FIG. 9 screens on Publisher Store 125. The feeds are used to update an internal database of SSP Reporting component 152.

Since sponsorship messages and advertisements on User Store 115 blend into the store front's organic content, users are more likely to perceive them as contextually meaningful endorsements. By eliminating the need for demographic and behavioral attributes in bid requests, digital-content sponsorship facilitates privacy-mindful approach to advertising. As a result, the users are more likely to interact with sponsorship messages or ads.

At step 2705, whenever a publisher 120 comes to the Sponsorship screen FIG. 7, the store displays the levels of sponsorship support that the given digital content received in User Store 115. Over time, many publishers 120 would see the number of sponsors and the amount of support for their digital content grow to the point when they would start sensing the attraction power of sponsorship support.

In order to display the sponsorship statistics, the console of Publisher Store 125 queries the database of SSP Reporting 152 at Link 2410 and at Link 2510. The information summarizing the level of sponsorship on User Store 115 home and detail pages FIG. 7 gives a material and alluring incentive to publisher 120 to integrate the content with the store's sponsorship framework. Through separate widgets, publisher 120 who has not yet integrated its content may be advised that: sponsorship in User Store 115 results from advertiser's 130 desire to establish a mutually beneficial relationship, the level of in-content sponsorship may be significant, and open-auction advertisements would usually keep fill rates at reasonable levels. Publisher 120 who has an appealing content is more likely to sense and respond to the allure of prospective sponsorship support.

At step 2706, the prospects of content monetization through premium advertisements may draw into the digital-content sponsorship a new publisher, who will integrate its digital content(s) with the store's advertising kit 160.

When the digital content is integrated with advertising kit 160, the content starts sending the advertisement requests to supply-side platform 151 of the digital-content sponsorship framework. The serve, impression and click events start flowing from the digital content to supply-side platform 151 at Link 2206. Periodically, these events are collected and processed by SSP Reporting 152 at Link 2207, which also sets the status flag in all affinity records of the newly integrated digital content to “activated” at Link 2208.

At step 2707, when a sponsor of the newly integrated content comes to the home page on Advertiser Store 135, the content is presented at the top rack of the browsing area, reminding advertiser 130 to follow up with an in-content sponsorship campaign.

Advertiser Store 135 fills the top rack of the home-page browsing area by querying the content-description database at Link 2209 for the “activated” affinity records referencing advertiser 130.

One incentive to advertiser 130 to follow up with an in-content sponsorship campaign is the visibility that sponsorship advertisements get on relatively uncontested inventory after the sponsored content is integrated with the store's advertising kit 160. Through a programmatic-direct channel providing the content or impression guarantees, advertiser 130 also receives a premier treatment with respect to the digital content. Both of these factors are conducive to a higher return on investment. Advertiser 130 may also pursue an open-auction campaign, which helps keep the fill rates in available digital content at a high level. Advertiser's 130 incentive to do so is to reduce the cost of advertisements through non-guaranteed delivery while lowering the visibility of ads.

At step 2708, when the sponsor follows up with an in-content sponsorship campaign, the advertisements start serving the audience of the newly-integrated digital content.

When the sponsorship campaign is submitted at Link 2210, Campaign Manager 154 stores the associated definitions in its database and deletes the corresponding <content, advertiser 130> records from the affinity table of the content-description database at Link 2211. The campaign starts serving advertisements to the audience of the targeted digital content at Links 2503-2509.

By investing into the store's content-monetization framework through sponsorship or open-auction campaigns, advertiser 130 helps build critical demand for the growth of the framework. In addition to the incentives discussed in Step 2707, advertiser 130 may also count on a high-quality and continuously replenishing supply brought into the store by advertising demand through a process of natural selection.

At step 2709, publisher 120 who integrated its digital content with the store's advertising kit 160 is also likely to integrate it with telemetry kit 170 in order to grow the appeal of the inventory and achieve its appreciation among marketers.

Through telemetry kit 170, telemetry events FIG. 17 are submitted to Telemetry Reporting component 155 at Link 2302, which aggregates the data to produce the user activity, engagement, location and language statistics. The aggregated data is stored in a database of Telemetry Reporting component 155. When a publisher 120 or advertiser 130 comes to the appropriate place on Publisher Store 125 or Advertiser Store 135, respectively, the console of the store front queries the database at Link 2303 and at Link 2304 in order to render an engagement report. The reports are displayed on the corresponding screens of the two store fronts FIGS. 9 and 14, respectively.

Gaining the appreciation for the inventory is publisher's motivation to provide as detailed and as accurate information as possible and to enable the engagement statistics on Advertiser Store 135. Without the telemetry integration, publisher 120 would be hampering advertiser's 130 ability to assess the appropriateness of the content for targeting and, thereby, diminishing the content's prospects of monetization.

At step 2710, the diversification of available inventory and sharpened insights in Advertiser Store 135, together with the alluring effects of premier treatment with guarantees, are likely to attract a greater investment by more marketers.

The growing demand results in increased publisher loyalty and further diversification of integrated content and available inventory. The process continues, keeping the store's monetization framework growing. As the levels of demand and supply increase, the attractive forces between the entities involved become even more pronounced.

The above method is structured to employ digital-content sponsorship to support cognizant, in-good-faith acts of providing financial support to a publisher of digital content in exchange for advertising. It is designed to exploit the intrinsic attractive powers in the relationships between the advertisers, publishers and users for the purposes of solving the problem of growing supply and demand in digital-content monetization frameworks through automated means. The internal propulsion mechanism works to reduce the required sales force and costly business-development interventions typical of traditional computational advertising environments. It also serves as the store's mechanism for user acquisition, keeping both direct and indirect audience of the store growing, where direct audience is comprised of the users of the User Store and indirect of the combined audience of digital contents integrated with the store's advertising kit. Furthermore, the method serves as the mechanism for the monetization of the digital content store itself through the advertisements on User Store and revenue sharing for ads in the integrated digital contents.

The propulsion method reduces the likelihood of dramatic shifts in supply or demand through a synchronous growth of supply and demand, in which advertisers lead, as if they were sales people for the store, attracting a high-quality supply into the digital-content store through a process of natural selection. The method also utilizes one or more programmatic direct channels in order to achieve a level of price stability that further inhibits shifts in supply and demand. Furthermore, the method acts to deflate the problem of cyclic dependency chain between publishers, advertisers, and users through sponsorship on User Store and the synchronous growth of advertising supply and demand.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the use contemplated. The scope of the invention is to be defined by the following claims.

What is claimed is:

1. A self-service system for monetization of one or more digital contents, encompassing a greater pool of the one or more digital contents than what is integrated within it for the purposes of advertising, wherein the one or more digital contents is video, mobile apps, electronic books, electronic magazines, streaming digital TV, or retail digital content, comprising:
one or more databases;
the one or more databases coupled via a network;
one or more processors coupled to the one or more databases; and
one or more computing devices coupled to the one or more processors and the
one or more databases via the network; wherein the one or more processors are configured for:
generating a store having a User Store front, Advertiser Store front, and Publisher Store front; the User Store front enabling users to access or install the one or more digital contents and view content-sponsorship ads; the Publisher Store front enabling publishers to submit the one or more digital contents and monitor user engagement as well as sponsorship and advertising performance; and an Advertiser Store front enabling advertisers to browse, look up and view details corresponding to the one or more digital contents and select a combination of the one or more digital contents to target; the store configured either for a specialized digital content type or as a consolidated store front for different types of digital content; the store configured to enable monetization of digital content through advertising.

2. The system of claim 1, wherein the one or more processors are further configured for:
collecting, through a telemetry software development kit, for the publishers and advertisers, data about the user engagement with a digital content enabling the publishers to gradually gain appreciation among the advertisers for the inventory; and
providing monetary value for the publishers through an advertising software development kit.

3. The system of claim 2, wherein the one or more processors are further configured for:
displaying widgets and screens on the store fronts that present relevant information while increasing the likelihood of events favorable to the system's automated propulsion, the widgets and screens comprising: widgets on the User Store front displaying messages or advertisements of the advertisers sponsoring specific one or more digital contents; one or more sponsorship screens within the Publisher Store front presenting the publishers data about the sponsorship support on the User Store front and conveying the prospects of direct sponsorship should the publishers integrate the one or more digital contents with an advertising framework of the store; one or more advertising performance screens disposed within the Publisher Store front wherein the publisher of an integrated digital content is capable of monitoring the levels of in-content advertising performance; one or more screens on the Advertiser Store front enabling the advertisers to assess the synergy of their targeting objectives with the contextual aspects of the one or more digital contents and audience geographic, demographic and behavioral indicators.

4. The system of claim 3, wherein the one or more processors are further configured for:
generating a digital-content sponsorship platform articulated to support in-store and in-content advertising, wherein in-store advertising conveys an intent of the advertisers to sponsor a digital content, and in-content advertising enables monetization of the one or more digital contents.

5. The system of claim 4, wherein the one or more processors are further configured for:
generating a private marketplace with at least one premium channel and at least one channel for non-guaranteed delivery, wherein: at least one premium channel supports sponsorship campaigns, providing content guarantees for a fixed or minimum price; and at least one non-guaranteed channel reserved for open auctions, soliciting bids of the store's native and external demand.

6. The system of claim 5, wherein the one or more processors are further configured for:
generating a supply-side platform and a native demand-side platform, wherein the supply-side platform submits bids on behalf of the publishers and the native demand-side platform performs programmatic bidding on behalf of the store's native advertisers.

7. The system of claim 6, wherein the one or more processors are further configured for:
following a protocol for communication between the supply-side and demand-side platforms with special provisions for matching bid requests and bid responses in order to provide content guarantees to sponsorship campaigns.

8. The system of claim 7, wherein the one or more processors are further configured for:
generating and processing a number of system events, including content description, telemetry, bid request, bid response, and reporting events.

9. The system of claim 8, wherein the one or more processors are further configured for:
supporting the processes of content description, user telemetry, real-time bidding, and campaign management, wherein: the process of content description propagates content-description events from the Publisher Store front to the Advertiser Store front; the process of user telemetry generating user-engagement reports for both publishers or advertisers; the processes of real-time bidding procuring digital-content sponsorship ads in the User Store front as well as sponsorship or open-auction ads for in-content advertising; and the process of campaign management handling segment and campaign metadata used for programmatic bidding by the native demand side platform.

10. The system of claim 9, wherein the one or more processors are further configured for:
generating a campaign management embodiment, wherein the campaign management embodiment is configured to store and maintain campaign metadata used by the native demand side platform and plays a role in the content-description process.

11. The system of claim 10, wherein the one or more processors are further configured for:
generating reporting embodiments comprised of a content description component, telemetry component, supply side reporting component, and demand side reporting component, wherein: the content description reporting component prepares data about digital contents for detail pages in the Advertiser Store front; the supply side reporting component prepares sponsorship and advertising performance insights for the publishers; the demand side reporting aggregates data for the campaign performance insights in the Advertiser Store front; and the telemetry reporting component processes data for user engagement insights in the Publisher Store front and the Advertiser Store front.

12. The system of claim 11, wherein the one or more processors are further configured for:
propagating, by the content-description reporting component, content description events from the Publisher Store front to the Advertiser Store front; wherein the description events include publisher data about the content and its user demographics;
storing the description events in an internal database of the content-description reporting component;
rendering to the advertisers in one or more widgets of the Advertiser Store front the data about a digital content, a publisher, or a content category; and
rendering to the advertisers in one or more widgets of the Advertiser Store front the data about the demographics of the users of the one or more digital contents of the publishers.

13. The system of claim 12, wherein the one or more processors are further configured for:
allowing the advertisers to create segment definitions for content sponsorship on User Store, in-content sponsorship, or for open auctions;
allowing linking of segment definitions to different campaign definitions; and
storing the campaign and segment definitions as metadata for programmatic bidding in one or more databases used by the native demand-side platform.

14. The system of claim 13, wherein the one or more processors are further configured for:
updating an affinity table of a database of the content-description reporting component, adding the association between an advertiser and a digital content as soon as the advertiser targets the digital content through a sponsorship campaign on User Store front;
inserting a record into the affinity table for each digital content of the publisher whenever the advertiser's campaign targets a publisher;
activating the affinities of a digital content when the content integrates with the store's advertising software development kit, by setting the corresponding status field in the respective records of the affinity table;
retrieving the activated affinity records in order to present the newly integrated digital content to its sponsors on the home page of the Advertiser Store front; and
deleting the affinity records coupling the digital content with a sponsor after the sponsor targets said digital content with an in-content sponsorship campaign.

15. The system of claim 14, wherein the one or more processors are further configured for:
initiating a bidding process, through advertising software development kit, when a user comes to a place in User Store designated for sponsorship advertisements, wherein supply-side platform creates a bid request with the target and match objects and sends it to the native demand-side platform; wherein the native demand side platform attaches the appropriate bids to the bid response whenever there is a campaign targeting the digital content and the criteria specified in the match object are satisfied; wherein the native demand side platform sends the completed bid response to the supply-side platform; wherein the supply-side platform verifies that the match criteria are satisfied, decides the winning bids, informs the native demand-side platform about the winning bids, and notifies the advertising software development kit of the winning bids; wherein the advertising software development kit communicates with the store's ad-serving component in order to render the winning sponsorship messages or ads in the viewable places on the User Store.

16. The system of claim 15, wherein the one or more processors are further configured for:
initiating a bidding process, through advertising software development kit, when a user of an integrated digital content comes to a place designated for advertisements, wherein supply-side platform creates a bid request with the target and match objects and sends it to the native and external demand-side platforms; wherein the demand side platforms attach appropriate bids of in-content sponsorship or open-auction campaigns to bid responses and send the responses to the supply-side platform; wherein the supply-side platform decides the winning bids, informs the demand-side platforms of the decisions, and notifies the advertising software development kit of the winning bids; wherein the advertising software development kit communicates with the ad-serving component in order to render the advertisements in viewable places of the digital content.

17. The system of claim 16, wherein the one or more processors are further configured for:
generating, by the supply-side platform or the advertising software-development kit, reporting events about the bidding auction and subsequent user interactions with the ads, respectively; and
forwarding the one or more reporting events to the store's supply-side and demand-side reporting components.

18. The system of claim 17, wherein the one or more processors are further configured for:
processing, by the store's supply-side reporting component, the reporting events in order to produce aggregated statistics about the levels of sponsorship support that the digital content of the publisher has received in User Store and, for digital content that have been integrated with the store's advertising framework, to produce aggregated advertising-performance reports for the publishers of the digital contents;
storing the aggregated sponsorship and advertising-performance statistics in the database of the supply-side reporting component;
rendering to the publisher in one or more widgets of the Publisher Store front the aggregated statistics about the levels of sponsorship support that the digital content has received in User Store; wherein, if the publisher has not integrated the digital content with the store's advertising software development kit, the data would present the prospects of direct sponsorship should the publisher integrate the digital content with the store's advertising software development kit; and
rendering to the publisher the data in one or more widgets of the Publisher Store front the aggregated statistics about the in-content advertising performance, if the digital content is integrated with the store's advertising framework.

19. The system of claim 18, wherein the one or more processors are further configured for:
processing, by the store's demand-side reporting component, the reporting events in order to produce aggregated statistics for advertisers about campaign performance;
storing the campaign-performance statistics in the database of the demand-side reporting component;
rendering to the advertiser in one or more widgets of the Advertiser Store front the aggregated campaign-performance data.

20. The system of claim 19, wherein the one or more processors are further configured for:
processing, by the store's telemetry reporting component, telemetry events in order to produce aggregated statistics about the levels of user engagement on digital contents that have been integrated with the store's telemetry software development kit; the aggregated data configured to include statistics about user activity and engagement, geo and language distributions, and other kinds of aggregated telemetry data.
storing the engagement statistics grouped by content or publisher in the database of the telemetry reporting component;
rendering to the publisher in one or more widgets of the Publisher Store front the aggregated statistics about user engagement with the digital content; and
rendering to the advertiser in one or more widgets of the Advertiser Store front the aggregated telemetry reports for a digital content or across contents of a publisher.

21. The system of claim 20, the one or more processors further configured for:
accommodating digital content beyond the one that uses the system's distribution, advertising, and telemetry features.

22. The system of claim 20, the one or more widgets configured on the User Store for:
presenting sponsorship advertisements in positions other than the home and detail pages.

23. The system of claim 20, the private marketplace comprising several channels above and below the open auctions of the private marketplace, wherein the programmatic-direct channels above the open auctions are configured to provide different types of guarantees to the advertisers; and the channels below the open auctions are usable for the publishers' engagement campaigns targeting the audience of the store or the digital content.

24. The system of claim 20, the one or more processors configured for:
employing an automated framework capable of sending at predetermined intervals direct marketing notifications to advertisers about the featured or newly added content, via email or mobile push.

25. The system of claim 20, the one or more processors further configured for:
employing, through the digital content store, direct notifications to the publishers about the level of sponsorship their digital content received in both the User Store front and within the one or more digital content.

26. The system of claim 20, the store's digital-content sponsorship framework further comprising provisions for performance advertising or direct marketing campaigns.

27. The system of claim 20, the store's digital-content sponsorship framework further comprising provisions for the publishers' deep engagement campaigns.

28. The system of claim 20, the one or more processors configured for:
allowing marketers to select from a variety of different payment methods or models.

29. The system of claim 20, the one or more processors further configured for:
employing a recommendation framework that provides the advertisers personalized views on the Advertiser Store front of the digital content matching the past or current targeting criteria as collected in the one or more databases.

30. The system of claim 20, the one or more processors further configured for:
generating an automated detection and incentives engine, delivering incentives to advertisers or publishers to generate certain events favorable for the growth of supply and demand upon detecting underrepresentation of such events.

31. A computer implemented method, for the purposes of growing advertising supply and demand in an automated fashion, the method comprising:
receiving, by a self-service system for monetization of one or more digital content, through a Publisher store, over a network a digital content and publisher's information describing the content and its audience; the self-service system for monetization of one or more digital content having one or more processors; one or more memory devices coupled to the one or more processors; and one or more computerized programs, wherein the one or more computerized programs are stored in the one or more memory devices and executed by the one or more processors;
allowing, by the self service system for monetization, advertisers to examine details of various digital content on an Advertiser Store and decide which contents, publishers or categories of content best serve targeting objectives;
enabling, by the self service system for monetization, the advertisers to submit campaigns for digital-content sponsorship on a User Store;
enabling, by the self service system for monetization, users to view sponsorship messages or ads on the User Store;
enabling, by the self service system for monetization, the publishers to view levels of sponsorship on the User Store for their digital content;
providing, by the self service system for monetization, the publishers with the means to integrate their digital content with the store's advertising framework for the purposes of monetizing the digital content on the Publisher Store;
enabling, by the self service system for monetization, the advertisers to be the first to see when a digital content they sponsored integrates with the store's advertising framework;
collecting, by the self service system for monetization, data pertaining to user engagement through a telemetry software development kit;
providing, by the self service system for monetization, monetary value to publishers through in-content sponsorship or open auctions advertisements, utilizing an advertising software development kit.

32. The method of claim 31, further comprising: providing, by the self service system for monetization, incentives to the advertisers to submit sponsorship campaigns targeting a digital content in the User Store in order to: establish a mutually beneficial relationship with a publisher of the one or more digital content that has an appropriate audience; benefit from the fact that sponsorship ads in the User Store are presented in premium placements of the store front; achieve a gradual amplification of the marketing message as the user goes through the User Store into the sponsored digital content; take advantage of the store's guarantees that a sponsor will receive an advance notice when the targeted digital content is integrated, ahead of the advertisers who are not sponsoring the digital content; and target directly, through a premium channel, the audience of the digital content as soon as the digital content is integrated with the store's advertising framework.

33. The method of claim 32, further comprising through the store's advertising framework the sponsorship messages or advertisements to the users of the User Store, wherein the advertisements are procured through real-time bidding among the store's bidders for sponsorship, wherein the bid responses and subsequent user interactions with the winning ads, such as views and clicks, are recorded by the digital-content sponsorship platform;
wherein the sponsorship messages, which do not disturb the organic nature of the User Store, are more likely to be perceived as contextually-meaningful endorsements; and wherein the users are more likely to interact with sponsorship messages or ads because digital-content sponsorship facilitates a privacy-mindful approach to advertising.

34. The method of claim 33, further comprising: enabling, by the self service system for monetization, a console of the Publisher Store to query the database of a supply side reporting component in order to summarize to the publisher of a digital content the diversity of sponsors and the amount of sponsorship on the User Store; wherein separate widgets on the Publisher Store advising a publisher who have not integrated their digital content, that sponsorship in the User Store is a precursor to in-content sponsorship, wherein the publishers would start sensing the alluring effects of sponsorship support as the number of sponsors and the amount of their support grows.

35. The method of claim 34, further comprising: enabling, by the self service system for monetization, the publishers attracted by the prospects of sponsorship support and content monetization through premium advertising to integrate their digital content with the store's advertising software development kit and, thereby, bring the digital content's audience into the digital-content sponsorship framework; wherein the digital content will immediately start sending ad requests to the supply-side platform of the digital-content sponsorship framework; and wherein system events, such as impressions and clicks, will start flowing to the supply side reporting and demand side reporting components of the store for further processing.

36. The method of claim 35, further comprising: employing, by the self service system for monetization, the processes of content description and campaign management in order to inform the sponsors of a newly integrated content and provide them incentives to follow up with in-content sponsorship campaigns, enabling a high return on advertising investment; wherein the sponsorship advertisements achieve a predetermined amount of visibility on relatively uncontested inventory after the sponsored digital content is integrated with the store's advertising software development kit; wherein the sponsor is capable of taking advantage of content or impression guarantees supported by premium channels of the digital-content sponsorship framework.

37. The method of claim 36, further comprising: serving, by the self service system for monetization, through the store's advertising framework, the advertisements of sponsorship campaigns to the audience of a newly integrated digital content by conducting real-time bidding auctions through the premium channels of the private marketplace.

38. The method of claim 37, further comprising: increasing, by the self service system for monetization, the fill rates in available digital content by allowing the advertiser to pursue open-auction campaigns, reducing the cost of advertisements through non-guaranteed delivery, while lowering the visibility of advertisements as well as the chances of marketing success.

39. The method of claim 38, further comprising:
allowing, by the self service system for monetization, the publishers to integrate the digital content with the store's telemetry software development kit; and
employing, by the self service system for monetization, the process of telemetry reporting, enabling advertisers to see and assess the geographic, linguistic and behavioral attributes of the audience and, thereby, further grow the appeal of the content's inventory.

40. The method of claim 39, further comprising: attracting, by the self service system for monetization, a greater demand by more advertisers through premier treatment with guarantees, more diverse inventory, and sharper insights in the Advertiser Store; wherein the growing demand would work to: increase publisher loyalty, diversify available inventory, propagate further the desirable effects, and keep the store's supply and demand growing.
